(19) United States
(12) Patent Application Publication
(10) Pub. No.: US 2013/0046551 A1
(43) Pub. Date: Feb. 21, 2013

(54) METHODS AND APPARATUS FOR PATIENT ORDER MANAGEMENT

(71) Applicants: Katherine Vahle, Boston, MA (US); Elizabeth Dunn, Winchester, MA (US); Derek Hedges, Medway, MA (US); David Kreiss, Wellesley, MA (US); Kate Levesque, Littleton, MA (US); Vernon Jack Nye, Cedar Park, TX (US)

(72) Inventors: Katherine Vahle, Boston, MA (US); Elizabeth Dunn, Winchester, MA (US); Derek Hedges, Medway, MA (US); David Kreiss, Wellesley, MA (US); Kate Levesque, Littleton, MA (US); Vernon Jack Nye, Cedar Park, TX (US)

(21) Appl. No.: 13/211,963

(22) Filed: Aug. 17, 2011

(51) Int. Cl. G06Q 50/00

(52) U.S. Cl. 705/2

(57) ABSTRACT

Methods and apparatus for facilitating a referral between healthcare providers associated with a practice management system. An order facilitation service hosted by the practice management system enables a healthcare provider the ability to interactively search for and select a provider based on a search request. The practice management system may store detailed information about one or more of the healthcare providers associated with the practice management system to facilitate a provider selection process. Providers may also specify preferences for referrals and the preferences may be used during a consult order generation process to ensure that the consult order includes information that a particular receiving provider may require.

### BACKGROUND

The provision of healthcare services to a patient by a healthcare provider often includes providing consultations or referrals for the patient to other “receiving” healthcare providers (e.g., specialist physicians, laboratories, imaging centers, etc.), who administer additional healthcare services to the patient. For example, a patient may initially be seen by a primary care physician (PCP) who may refer the patient to a specialist, such as an orthopedic surgeon, and to an imaging center to acquire a magnetic resonance image (MRI). After the patient's visit to the PCP, the patient may be responsible for scheduling a visit to the specialist and the imaging center. Upon arriving at the receiving provider, the patient may be required to complete one or more health information forms including information related to medical insurance, medical history, and/or other health information. After the visit to the receiving provider, the patient may be provided with test results and/or a further consultation, and the patient, the receiving provider, or the referring (i.e., ordering) provider may be responsible for updating the ordering provider with results from the consultation with the receiving provider.

### SUMMARY

Some embodiments of the present invention are directed to a method of facilitating a referral between healthcare providers. The method comprises receiving a search request from an ordering provider to search for a receiving provider for the referral, wherein the search request includes an order type for the referral; retrieving based, at least in part, on the order type, provider information for a plurality of healthcare providers associated with a practice management system; and displaying the retrieved provider information as search results to facilitate a selection of the receiving provider for the referral.

Some embodiments are directed to at least one non-transitory computer-readable storage medium encoded with a plurality of instructions that, when executed by a computer, perform a method of determining transaction costs associated with an order facilitation service hosted by a practice management system. The method comprises receiving via the order facilitation service, a selection of a receiving provider by an ordering provider; determining with at least one processor, whether the receiving provider is subscribed to the order facilitation service; assessing a first transaction cost to the receiving provider when it is determined that the receiving provider is subscribed to the order facilitation service; and assessing a second transaction cost to the ordering provider when it is determined that the receiving provider is not subscribed to the order facilitation service.

Some embodiments are directed to a computer system, comprising: at least one storage device configured to store a plurality of computer-readable instructions; and at least one processor programmed to execute the plurality of computer-readable instructions to perform a method of tracking referrals between healthcare providers associated with a practice management system. The method comprises determining at least one performance metric for at least one of the healthcare providers, wherein the at least one performance metric includes a turn around time for referrals sent to the at least one of the healthcare providers; and generating at least one referral report for the at least one of the healthcare providers, wherein the at least one referral report includes at least one visualization of the at least one performance metric.

Some embodiments are directed to a method of generating a clean consult order for a referral for a patient, wherein the referral is between an ordering provider and a receiving provider. The method comprises receiving preference information for the receiving provider, wherein the preference information includes information which the receiving provider requires to ensure that the receiving provider will be reimbursed by a healthcare payer for the patient; generating a referral page including at least some fields for specifying the preference information; receiving input from the ordering provider specifying at least some of the preference information; generating the clean consult order based, at least in part on the input from the ordering provider.

Some embodiments are directed to a method of facilitating a referral between an ordering provider and a receiving provider associated with a practice management system including a scheduling component and a communication component. The method comprises determining whether the referral has been completed by accessing scheduling information for the receiving provider, wherein the scheduling information is stored by the scheduling component; sending via the communication component, at least one communication to the receiving provider and/or a patient associated with the order when it is determined that the referral has not been completed.

Some embodiments are directed to a computer system, comprising: at least one processor configured to host a practice management system, wherein the practice management system includes an order facilitation service to which healthcare providers associated with the practice management system may subscribe; and at least one data store associated with the practice management system, wherein the at least one data store is configured to store a plurality of rules that interact with the order facilitation service to facilitate referrals between the healthcare providers associated with the practice management system.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of a practice management system in accordance with some embodiments of the invention;

FIG. 2 is a schematic diagram of a referral relationship in accordance with some embodiments of the invention;

FIG. 3 is a flow chart of a referral process in accordance with some embodiments of the invention;

FIG. 4 is a portion of a user interface for entering referral information in a practice management system;

FIGS. 5A and 5B are exemplary portions of a user interface displaying a detailed referral page in accordance with some embodiments of the invention;

FIG. 6 is a portion of a user interface displaying a referral page for an independent provider in accordance with some embodiments of the invention;

FIG. 7 is a portion of a user interface for entering referral information for an imaging consult referral, in accordance with some embodiments of the invention;

FIG. 8 is a portion of a user interface for entering referral information for a laboratory consult referral, in accordance with some embodiments of the invention;

FIG. 9 is a flow chart of a provider searching process in accordance with some embodiments of the invention;

FIG. 10 is a portion of a user interface for entering preferences information for a provider, in accordance with some embodiments of the invention;

FIG. 11 is an exemplary clean consult order facsimile document that may be generated in accordance with some embodiments of the invention;

FIG. 12 is a flow chart of an authorization retrieval process in accordance with some embodiments of the invention;

FIG. 13 is an exemplary referral report generated in accordance with some embodiments of the invention;

FIG. 14 is a portion of a user interface for interactive scheduling of a patient at a receiving provider, in accordance with some embodiments of the invention;

FIG. 15 is a flow chart of a transaction analysis process in accordance with some embodiments of the invention; and

FIG. 16 is a schematic of a network environment in which some embodiments of the invention may be employed.

### DETAILED DESCRIPTION

The present disclosure generally relates to inventive methods and apparatus for improving the efficiency of patient workflows as patients and their health information move between providers in a healthcare system. To this end, some embodiments of the invention relate to facilitating the transfer of patients and associated healthcare information in referral relationships between an ordering provider such a primary care provider (PCP) and a receiving provider such as a medical service facility (e.g., lab, imaging center, etc.) or another secondary healthcare provider (e.g., a specialist).

Applicants have recognized and appreciated that conventional methods for processing referrals may be improved by providing an integrated health information system that enables providers to coordinate the transfer of health information including, but not limited to, sharing of consult orders, clinical data, payer information, patient compliance information, and reporting functionality.

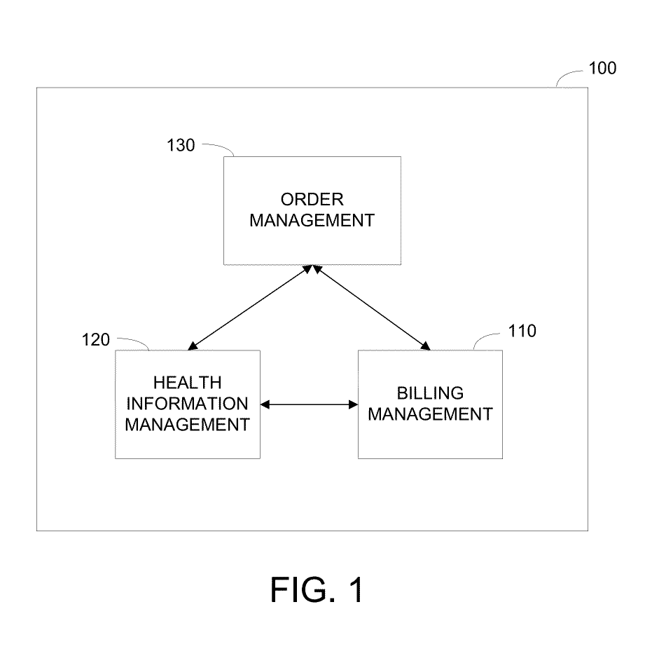

In accordance with some embodiments, a practice management system, which hosts an electronic health records (EHR) system for a plurality of healthcare providers may facilitate a transfer of information between an ordering provider and a receiving provider. A block diagram of an exemplary practice management system that may be used to implement some embodiments of the invention is shown in FIG. 1. Practice management system 100 may be a networked system that includes a plurality of components configured to perform tasks related to specific functions within the practice management system to facilitate management of information for healthcare providers.

Exemplary practice management system 100 includes billing management component 110, which is configured to facilitate the collection and tracking of claims filed by the healthcare provider to a plurality of payers (including patients) to ensure that the healthcare provider is properly compensated for medical services rendered to patients treated by the healthcare provider. Practice management system 100 also includes health information management component 120, which is configured to store electronic health information such as EHR data for patients of the healthcare provider. Practice management system 100 also includes order facilitation component 130, which interacts with health information management component 120 and billing management component 110 to facilitate a transfer of patients and health information between healthcare providers.

Although practice management system 100 is only shown as having three components, it should be appreciated that practice management system 100 may include any number of components that interact in any suitable way and embodiments of the invention are not limited in this respect. For example, in some embodiments, practice management system 100 may include a communications component configured to send and/or receive one or more communications with a plurality of patients having medical information stored by health information management component 120. Furthermore, some or all of the components in practice management system 100 may interact by sharing data, triggering actions to be performed by other components, prevent actions from being performed by other components, storing data on behalf of other components, and/or interacting in any other suitable way.

In an effort to coordinate medical services, groups of healthcare providers are often organized into a referral network that enable providers in the network to efficiently refer patients to other providers in the network. The referral networks may be established in any suitable way. For example, some payers, such as insurance companies, may establish referral networks of healthcare providers that provide healthcare services to patients who subscribe to a particular health insurance provider or plan. By forming such referral networks, providers may be incentivized to refer patients to in-network providers rather than out-of-network providers.

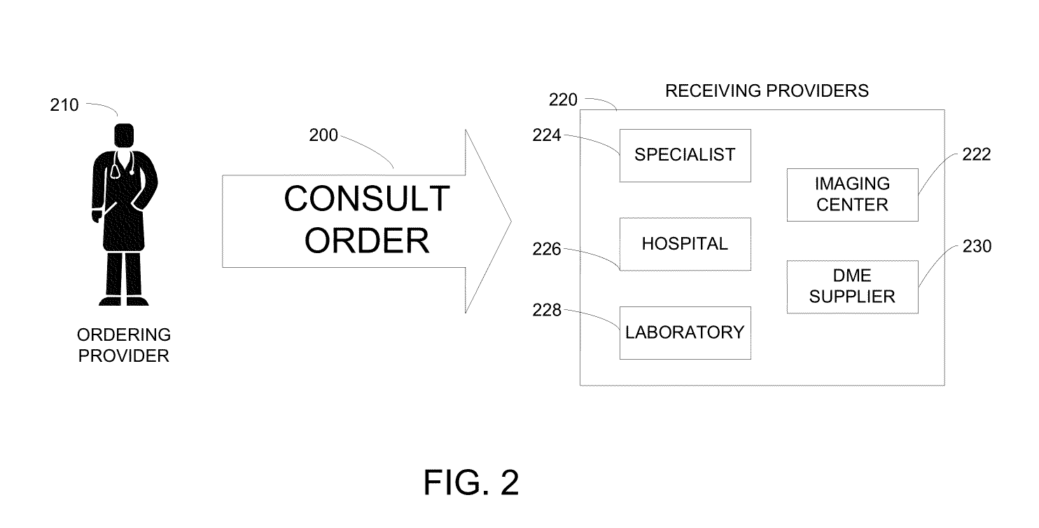

FIG. 2 shows a schematic illustration of medical providers involved in a patient referral system in accordance with some embodiments of the invention. A consult order 200 is generated by ordering provider 210 such as a primary care physician. The ordering provider 210 may select a receiving provider 220 to which the consult order will be sent and the selection may be informed by a plurality of factors including the type of consult order. For example, if the consult order relates to acquiring an MRI for a patient, the ordering provider 210 may select an imaging center 222 as the receiving provider 220 for the consult order. Receiving providers 220 in accordance with some embodiments of the invention may include physicians, such as specialist 224, or entities including, but not limited to, imaging center 222, hospital 226, laboratory 228, and durable medical equipment supplier 230. Other types of receiving providers may also participate in referral transactions described in further detail below and embodiments of the invention are not limited in this respect.

The inventors have recognized and appreciated that some conventional referral systems include workflow inefficiencies for moving patients and their healthcare information between medical practices or from a medical practice to an entity including, but not limited to, the entities described above. For example, in some instances, the number of providers in a network may be large and it may be challenging for an ordering provider to determine an appropriate receiving provider to select for a referral. Selection of an appropriate receiving provider may be further complicated due to a lack of readily-available information about possible receiving providers at the time of selection by an ordering provider. Accordingly, some embodiments are directed to methods and apparatus for facilitating a selection of a receiving provider by an ordering provider during the generation of consult order.

Another workflow inefficiency in some conventional referral systems involves the transfer of health information from one provider to another provider. Often a receiving provider may request that particular clinical data be transferred when a patient is referred to the provider. For example, some receiving providers may need information related to a number of approved visits and/or an authorization code for the referred patient to ensure that the receiving provider will be adequately reimbursed by one or more payers (e.g., insurance companies) for medical services provided to the referred patient. However, the ordering provider who is generating a consult order may not be aware of the particular information required by each receiving provider when the receiving provider is selected. In such situations, the amount and/or type of health information that is provided to a receiving provider in connection with a patient referral may be inadequate and the providers in the referral relationship may require several communications to enable the receiving provider to acquire the needed information. Accordingly, some embodiments of the invention are directed to providing receiving providers with a “clean” consult order that reduces the above-described workflow inefficiency by enabling receiving providers to specify the information that they require and indicating the specified information to an ordering provider prior to generating a consult order.

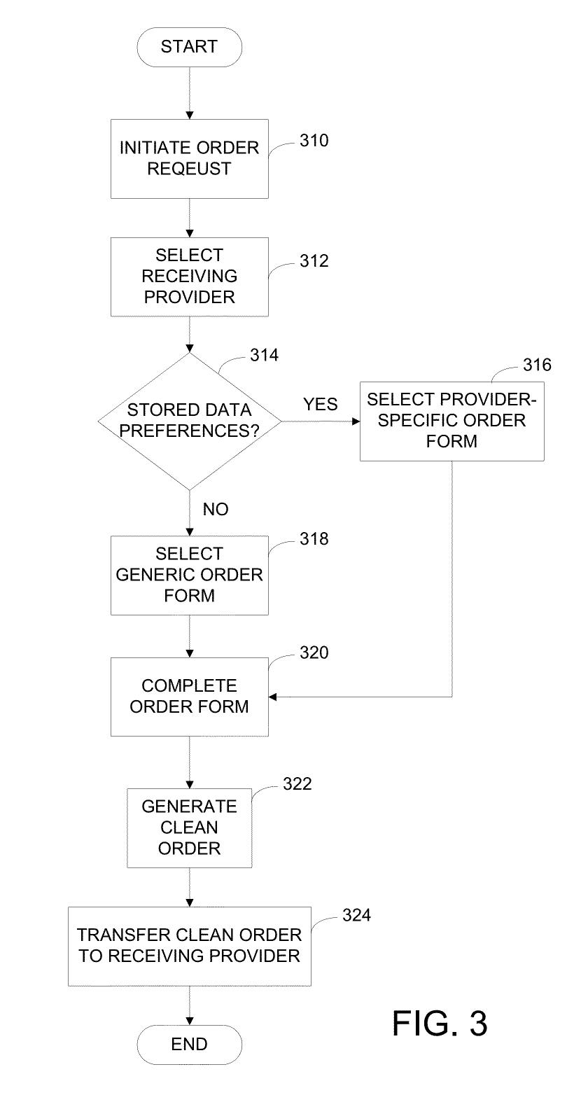

FIG. 3 illustrates acts in an exemplary process for generating a consult order in accordance with some embodiments of the invention. In act 310, an ordering provider initiates an order request. The request may be generated for any purpose related to a patient's medical care and embodiments of the inventions are not limited by the particular type of consult order. For example, an ordering provider may generate a consult order to refer a patient to a specialist for further examination and testing or an ordering provider may generate a consult order to refer a patient to a medical supplies company for purchase or rental of durable medical equipment such as a blood glucose monitor for a diabetic patient or a nebulizer for a patient with asthma.

In some embodiments, generating a consult order may include instructing the ordering provider to specify an order type. Order types for a consult order include, but are not limited to, physician, imaging, laboratory, durable medical equipment, surgery, pharmaceutical, vaccine, and admission. As discussed in detail further below, search results for receiving providers may be filtered by the order type specified by an ordering provider.

Once a consult order has been requested, the process proceeds to act 312 where the ordering provider selects a receiving provider for the consult order. In some embodiments, the ordering provider may enter search criteria into a user interface that searches for receiving providers associated with a practice management system that meet the search criteria specified by the ordering provider. An ordering provider may interact with the user interface to narrow down the search results to select an appropriate receiving provider for the consult order. As described in more detail below, in some embodiments, the process of selecting a receiving provider may be facilitated by returning search results with descriptive information associated with one or more providers listed in the search results.

After a receiving provider is selected, the process proceeds to act 314 where it is determined whether there are stored data preferences associated with the selected provider. As described in more detail below, in some embodiments, a receiving provider may specify clinical data that the provider may require as a condition of accepting the referral from the ordering provider. For example, a receiving provider that is a laboratory may need to know the patient's age to determine whether a substance detected within a blood sample is within a normal range for the patient's particular age range. Provider-specific information may be stored by a portion of the practice management system and, when present, may be used to generate a provider-specific form that an ordering provider may complete when generating a consult order in accordance with some embodiments of the invention.

If it is determined in act 314 that the selected provider is associated with stored data preferences, then the process proceeds to act 316 where a provider-specific order form is generated based, at least in part, on the stored data preferences. The provider-specific form may be generated in any suitable way, as aspects of the invention are not limited in this respect. For example, a generic form for a particular order type may be modified based on stored data preferences or one or more customized forms including stored data preferences for particular providers may be stored by the practice management system and may be retrieved in response to selecting a particular provider.

If it is determined in act 314 that the selected provider is not associated with stored data preferences, then the process proceeds to act 318 where a generic order form stored by a practice management system may be selected. In some embodiments, generic order forms may be classified into different categories based on order type and a generic order form may be selected based, at least in part, on an order type determined from the order request and/or information associated with the selected receiving provider. For example, an ordering provider may select an order type of “physician.” Based on this selection, in act 318 a generic order form for the order type “physician” may be selected. It should be appreciated that any number or type of generic order forms may be stored by the practice management system and embodiments of the invention are not limited in this respect.

After a provider-specific order form has been selected in act 316 or a generic order form has been selected in act 318, the process proceeds to act 320 where the selected order form is completed. In some embodiments, the selected order form may be completed by an ordering provider interacting with a user interface that displays the order form. However, in other embodiments, at least a portion of the selected order form may be completed automatically based, at least in part, on information stored by the practice management system. For example, a health information management component of the practice management system may include an electronic health record (EHR) for the patient associated with the consult order and the selected order form may be completed with information included in the patient's EHR. It should be appreciated that information other than an EHR may also be used to complete some or all of the selected order from and embodiments of the invention are not limited in this respect.

In response to completion of the selected order form, the process proceeds to act 322 where a clean consult order is generated based on the information in the order form. In some embodiments, the clean consult order includes all of the information that a receiving provider has requested to complete the order. However in some embodiments, the clean consult order may include less than all of the information that a receiving provider needs to complete the order and embodiments of the invention are not limited in this respect.

After the clean consult order has been generated, the process proceeds to act 324 where the clean consult order is transferred to the receiving provider to complete the referral process. As discussed in more detail below, in some embodiments, the practice management system hosts an order facilitation service to which providers associated with the practice management system may subscribe. Receiving providers subscribed to the order facilitation service may receive an electronic notification that a consult order has been completed and uploaded to the practice management system. The consult order may be transferred to the receiving provider by enabling the receiving provider to access the completed order form via a user interface presented by the practice management system. However, it should be appreciated that the consult order may be transferred to the receiving provider in any suitable way and embodiments of the invention are not limited in this respect. For example the consult order may be transferred to the receiving provider via facsimile, mail, or in an electronic form such as email or electronic file.

As described above, the inventors have recognized and appreciated that some ordering providers using conventional referral systems may have difficulty selecting an appropriate receiving provider due, at least in part, to a lack of information available for providers during selection of a receiving provider. Accordingly, some embodiments of the invention are directed to methods and apparatus for facilitating a receiving provider selection process by providing the ordering provider with information that may help the ordering provider make an appropriate selection.

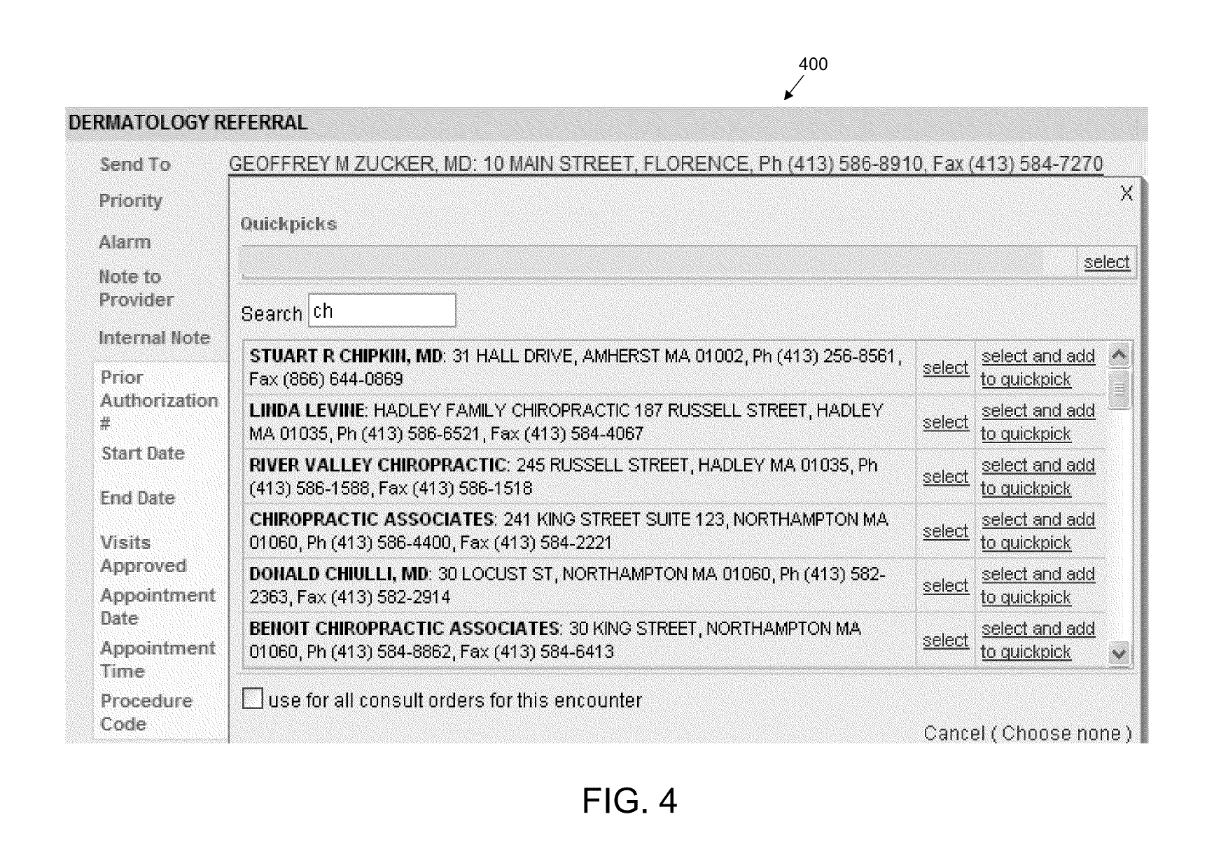

FIG. 4 illustrates an exemplary electronic referral page 400 of a user interface that an ordering provider may access to select a receiving provider in a conventional health information management system. Referral page 400 may enable an ordering provider to search for a receiving provider for a consult order during a patient encounter. In some instances, the search may be limited to in-network providers and each provider in the search may be listed as search results.

As shown in FIG. 4, the search results may contain names of providers and corresponding contact information. However, as described above, it may be difficult for a healthcare provider to select a receiving provider based on the limited amount of information about prospective receiving providers displayed as a portion of referral page 400. For example, the search for “ch” illustrated in FIG. 4 returns many different types of results including information for individual practitioners, practitioners associated with chiropractic healthcare facilities, and chiropractic healthcare facilities. Based on this limited information, a healthcare provider wanting to make a referral may be required to do additional independent research on the providers listed in the search results or a healthcare provider may simply choose one of the listed providers without determining which of the receiving providers may be best-suited provider for the particular patient.

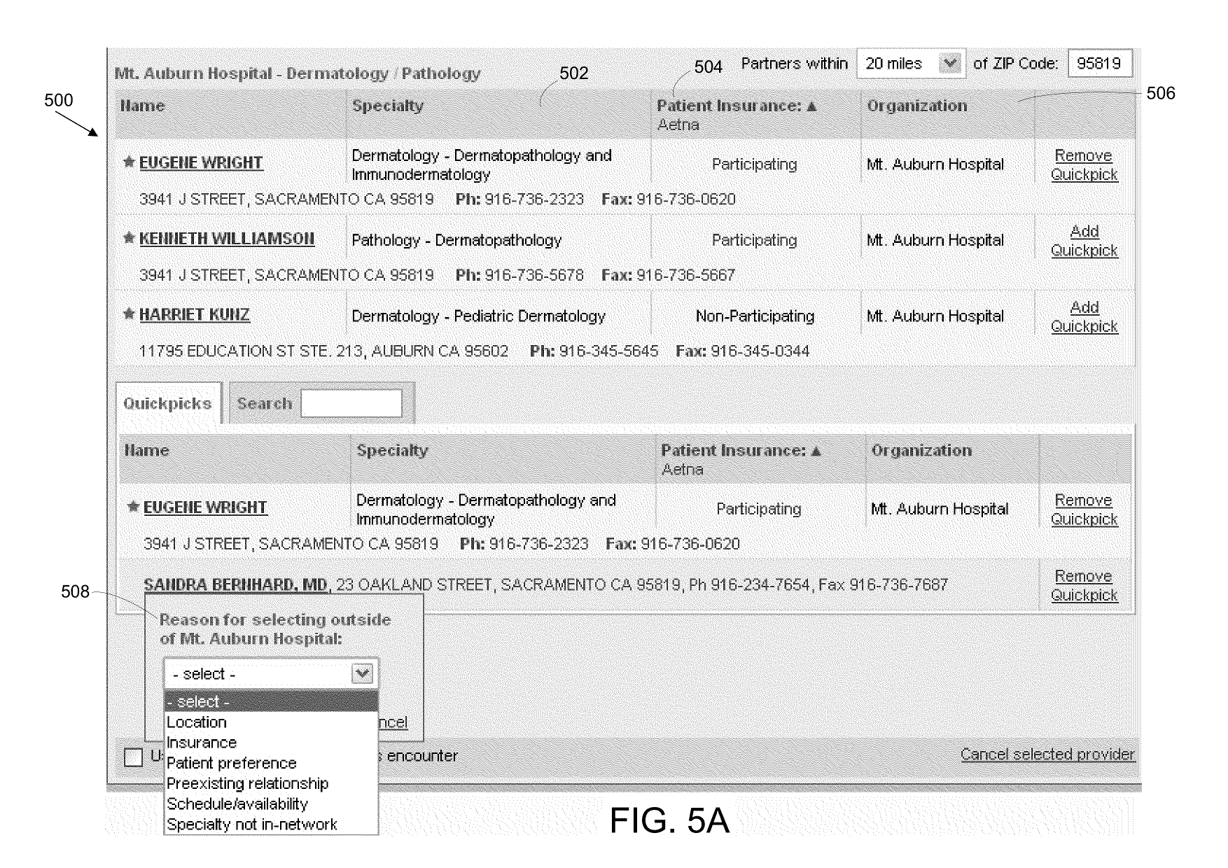

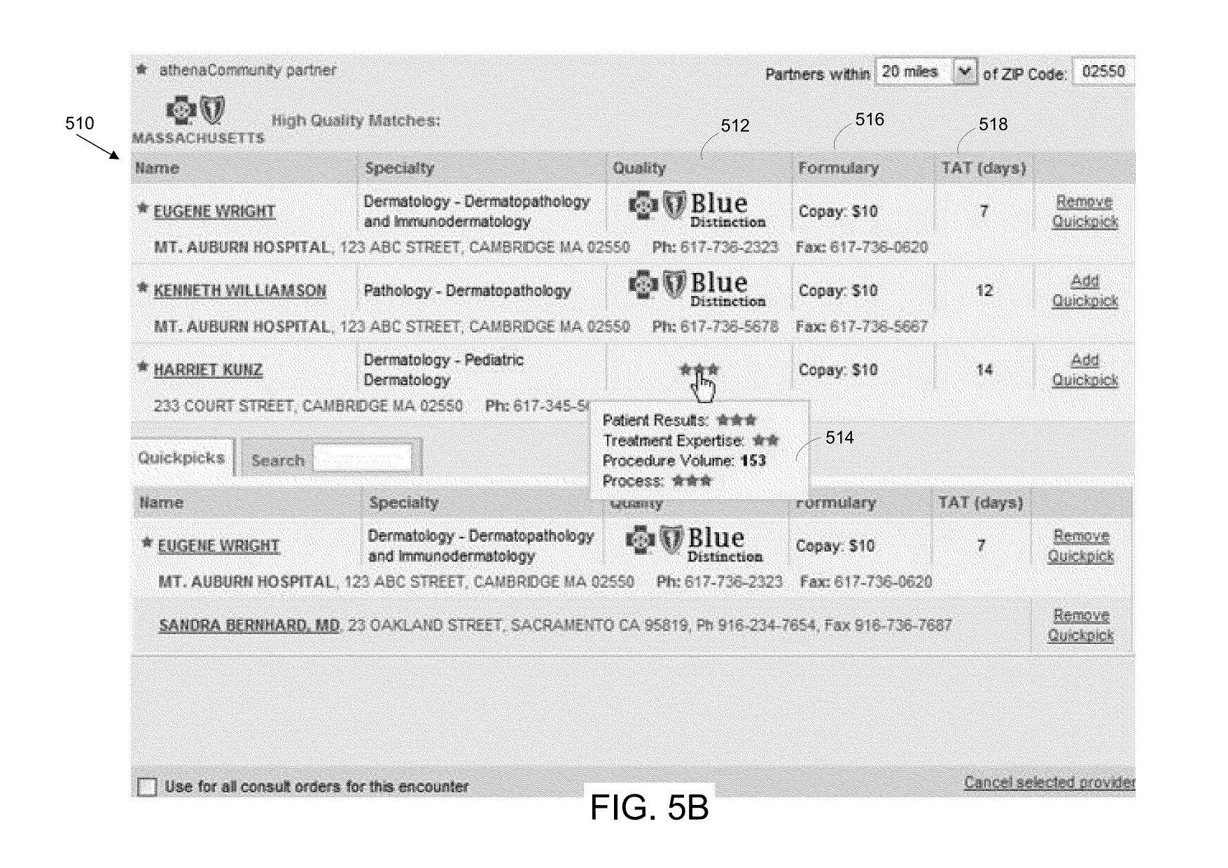

FIG. 5A illustrates an exemplary detailed referral page 500 as a portion of a user interface in accordance with some embodiments of the invention. In contrast to referral page 400, detailed referral page 500 includes one or more enhanced search and selection features that facilitate the selection of a receiving provider by an ordering provider. For example, rather than returning all results based on search terms entered by an ordering provider, some embodiments may filter the search results according to one or more criteria using information available within a practice management system. In some embodiments, results may be filtered based on an order type, such that only receiving providers having a specialty associated with the order type are returned as search results. Detailed referral page 500 may include specialty indicator 502 indicating a specialty of receiving providers included as search results in response to a search query. In the example shown in FIG. 5, a dermatology consult order is illustrated, and only receiving providers having a specialty associated with dermatology as indicated by specialty indicator 502 are included in the search results.

Detailed referral page 500 may also include other information that facilitates a selection of a receiving provider including insurance indicator 504. In some instances, it may be advantageous to refer a patient to a receiving provider who accepts a patient's health insurance plan rather than a receiving provider who does not. Accordingly, detailed referral page 500 may include insurance indicator 504 to facilitate an appropriate selection of a receiving provider for a particular patient based, at least in part, on types of insurance a receiving provider accepts.

During a referral process, it may be helpful for an ordering physician to know which organization a receiving provider is employed by and/or affiliated with. In some embodiments, detailed referral page 500 may include organization indicator 506 indicating an organization that a receiving provider is affiliated with to facilitate the selection of a receiving provider. In one implementation, an ordering provider may interact with comment selector 508 to specify a reason for selecting a receiving provider that is affiliated with a different organization than the organization of the ordering provider, although it should be appreciated that an ordering provider may choose not to provide a reason for selecting a particular receiving provider and embodiments of the invention are not limited in this respect.

FIG. 5B illustrates detailed referral page 510 as a portion of a user interface in accordance with some embodiments of the invention. Detailed referral page 510 includes additional indicators that an ordering provider may use to facilitate a selection of a receiving provider for a consult order. For example, detailed referral page 510 includes quality indicator 512, which may include information about preferred providers based on one or more factors including payer (e.g., insurance provider) preferences, patient preferences, or any other suitable quality measure. As shown in FIG. 5B, information in quality indictor 512 may be presented in any suitable manner including, but not limited to, using symbols, a combination of text and symbols, and text.

In some embodiments, an ordering provider may interact with quality indictor 512 to display additional quality information about the provider as shown in quality measure area 514. For example, in some embodiments, when an ordering provider places a mouse cursor over a particular entry in quality indicator 512, quality measure area 514 may appear, thereby presenting additional quality information to the ordering provider to facilitate their selection of a receiving provider. Although exemplary quality indicator 512 illustrated in FIG. 5B relates to information about particular payers associated with displayed receiving providers, it should be appreciated that other types of information associated with providers, which may be provided by, for example, a third party, such as a regulatory agency, may additionally or alternately be displayed by quality indicator 512 to facilitate a section of a receiving provider and embodiments of the invention are not limited in this respect.

Detailed referral page 510 also includes formulary indicator 516, which indicates a co-payment amount that a patient would have to pay if referred to a particular referring provider. Some patients may only want to be referred to providers with a particular co-payment amount. Accordingly, information sourced from healthcare payers, such as government and private payers may be used to determine a co-payment amount for at least some of the listed receiving providers to facilitate a selection of a receiving provider by an ordering provider.

Another factor that may be helpful for ordering providers to know when selecting a receiving provider is the receiving provider's average turn-around time, or other performance metric, for seeing patients that are referred to the provider. Accordingly, detailed referral page 510 includes performance indicator 518, which displays a performance metric (e.g., turn-around time) to facilitate a selection of a receiving provider. The information displayed by performance indicator 518 may be determined in any suitable way. For example, receiving providers may provide performance information to the practice management system for display by performance indicator 518. Preferably, performance information displayed by performance indicator 518 is determined by historical data for one or more performance metrics captured by the practice management system for the plurality of providers associated with the practice management system.

In some embodiments, information for healthcare providers displayed on detailed referral pages 500, 510 may be stored by one or more data stores associated with a practice management system. For example, some or all providers associated with the practice management system may interact with a user interface to input information that is useful to facilitate a referral process including, but not limited to, specialty information, insurance information, and organization information, as described above, and this information may be stored by the one or more data stores associated with the practice management system. In response to receiving a request to display search results for receiving providers, one or more processors in the practice management system may be configured to request information stored by the one or more data stores. The requested information may be retrieved and displayed as a portion of detailed referral page 500, as described above.

In some embodiments, the practice management system may include a global provider directory that stores information about providers with access to the practice management system. The information in the global provider directory may be input by a user such as a provider or staff at a medical practice or the information may be automatically collected based on a provider's usage of the practice management system and/or by collecting information from publicly available sources such as a provider's web page. The particular manner in which provider information is collected and stored by the practice management system is not limiting and such information may be collected and stored in any suitable way.

As discussed above, in some embodiments a practice management system may host an order facilitation service to which a plurality of providers associated with the practice management system may subscribe. In some embodiments, detailed referral page 500 may be configured to display search results including at least one receiving provider subscribed to the order facilitation service and at least one independent receiving provider not subscribed to the order facilitation service. As shown in FIGS. 5A and 5B, in some embodiments, providers subscribed to an order facilitation service may be designated in the search results using a symbol such as a star, whereas independent receiving providers may be designated with a different symbol (or not designated with a symbol at all).

The amount of information displayed on a referral page for each provider listed in the search results may be based, at least in part, on whether the provider is subscribed to the order facilitation service. Similarly, ordering providers who subscribe to the order facilitation service may be able to view more information on prospective receiving providers than independent receiving providers who are not subscribers to the service. For example, as illustrated in FIGS. 5A and 5B, search results for subscribing providers may include detailed information associated with the provider, whereas search results for independent receiving providers may include only basic demographic information.

Detailed referral pages 500, 510 may include an indication of any other type of suitable information that facilitates a selection of an appropriate receiving provider during a referral process, and embodiments of the invention are not limited in this respect. For example, in some embodiments, detailed referral pages 500, 510 may be configured to enable an ordering provider to designate one or more receiving providers as a “favorites” to indicate providers that the ordering provider frequently uses for consult orders. The ordering provider may then quickly identify and select a receiving provider designated as a favorite provider.

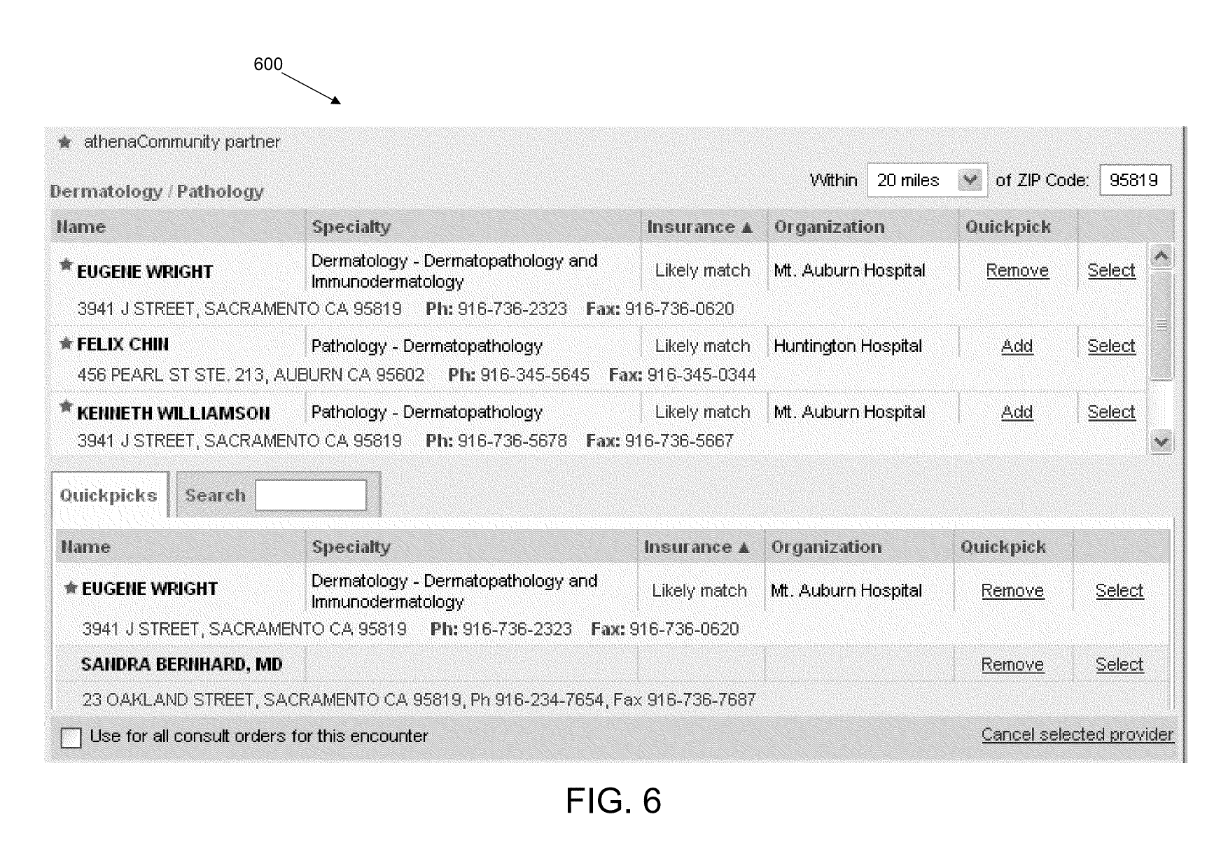

In some embodiments, an order facilitation component of a practice management system may be configured to enable independent providers (e.g., non-subscribers to an order facilitation service) the ability to search for receiving providers associated with the practice management system. FIG. 6 illustrates an exemplary referral page 400 including results of a search performed by an independent provider in accordance with some embodiments of the invention. In contrast to referral page 500, referral page 600 may display an alternative view of search results in response to a search query by an independent provider. For example, in referral page 600, insurance information may be provided as a probability of match rather than a certainty. Other changes in the view of search results for searches performed by independent providers are also contemplated and embodiments of the invention are not limited in this respect. For example, the order of presentation and/or the filtering of search results may be different for searches initiated by an independent provider than for searches initiated by a provider subscribed to the referral service.

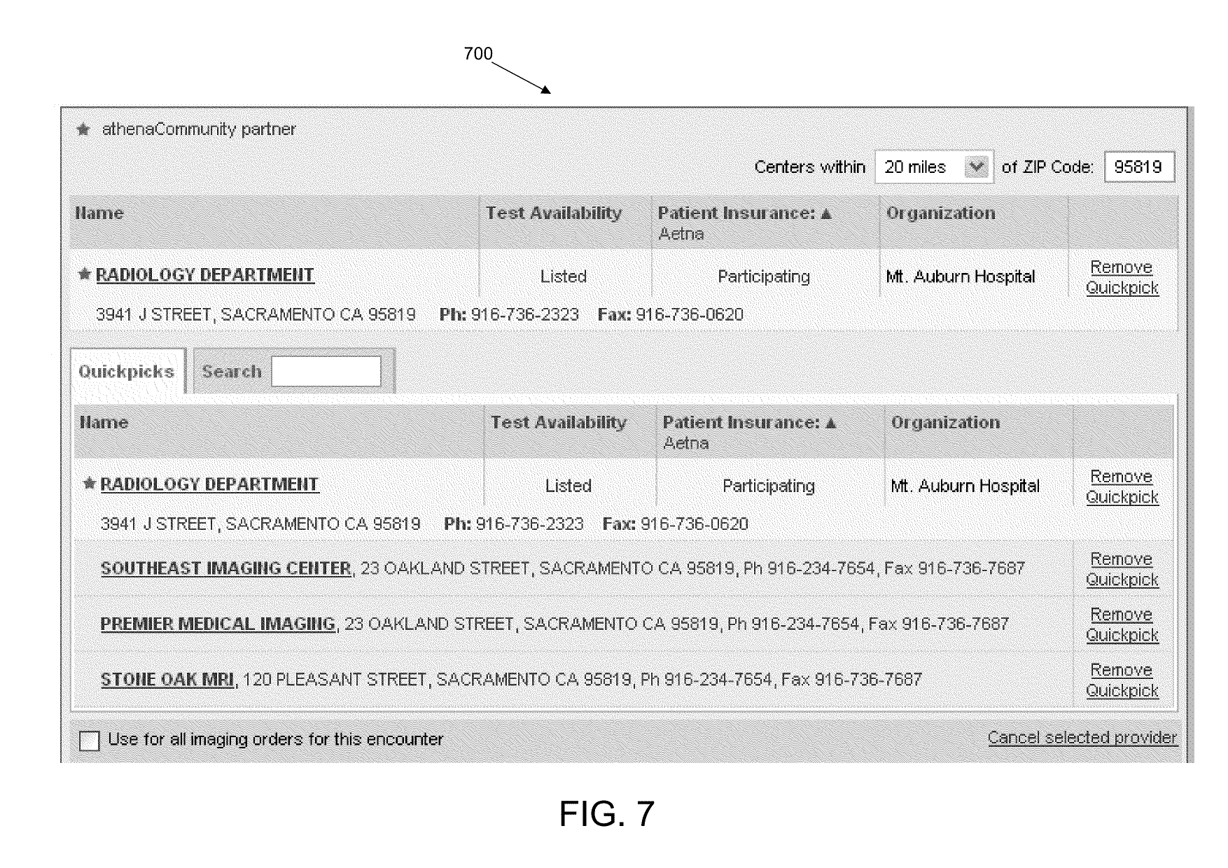

As discussed above, in some embodiments receiving providers may be physicians or receiving providers may be entities such as imaging centers or laboratories. The contents of a referral page may be based, at last in part, on the type of order requested by an ordering provider and/or the type of receiving provider associated with the order. An exemplary referral page 700 for an imaging order type is shown in FIG. 7. In an imaging order request, an ordering provider may order a particular test for a patient such as an MRI or CT scan and the ordering provider may select an imaging facility to refer the patient for completion of the ordered test.

The inventors have recognized that while some ordering providers associated with, for example, large hospitals, may refer patients in-house for imaging procedures, other ordering providers may have more difficulty in selecting an imaging center to refer patients. Accordingly, some embodiments are directed to collecting and storing information about a plurality of imaging centers by one or more components of a practice management system and displaying the collected information as search results in response to a referral search query for an imaging consult order. Some of the same considerations as described above for physician referral searches are also relevant for imaging center referral searches. For example, an ordering provider may want to know which imaging centers are able to perform the ordered test and/or which imaging centers accept a patient's insurance. Such information may be collected by an order facilitation component of a practice management system and displayed on referral page 700 as search results for an imaging consult request.

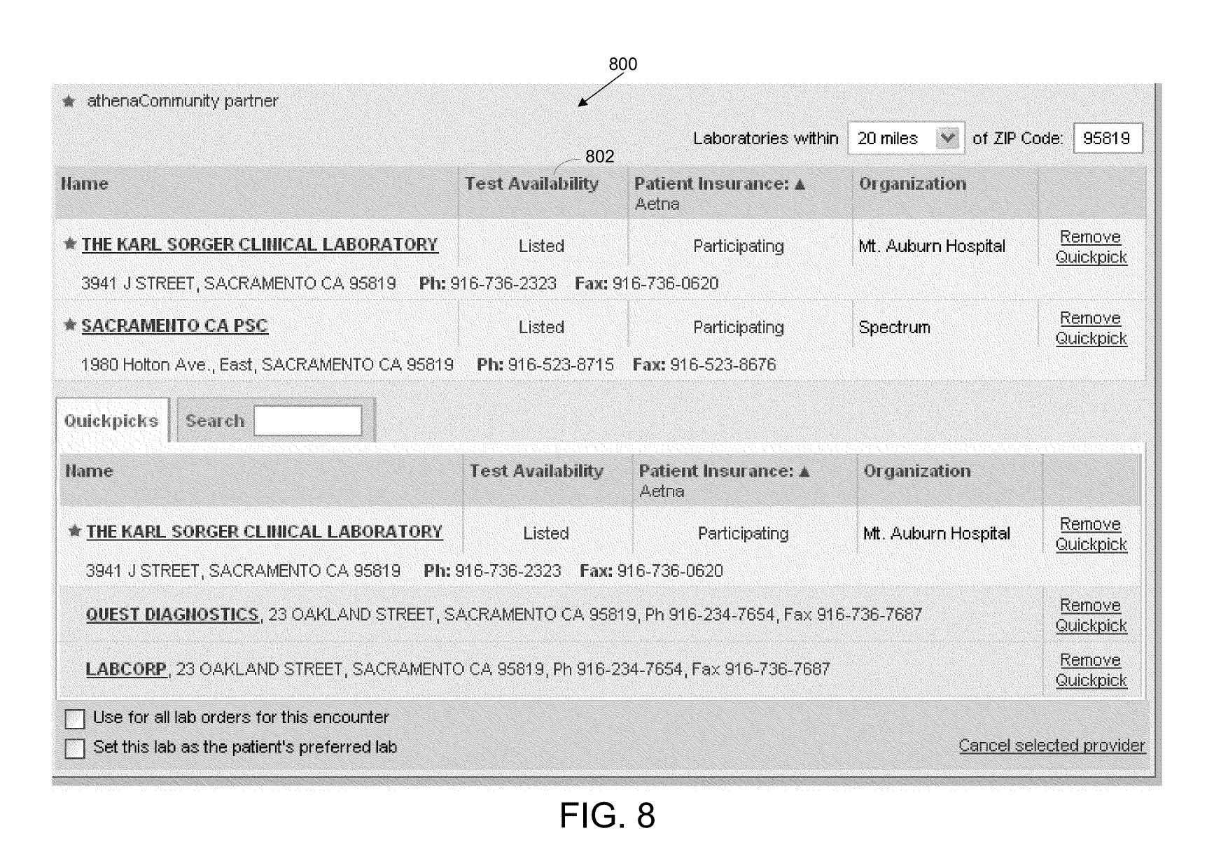

FIG. 8 illustrates an exemplary referral page 800 for a laboratory consult order that an ordering provider may interact with to select a receiving provider for analyzing a sample from a patient. Exemplary referral page 800 may include a plurality of fields that include information stored by a practice management system to facilitate a selection of a receiving provider for a particular patient and/or lab test. For example, a physician may recommend that a patient undergo a DNA test to screen for a particular genetic disorder identified in the patient's family medical history. If the physician's office is not able to process the patient's DNA sample, the physician as an ordering provider may interact with referral page 800 to select an appropriate laboratory to process the sample.

To facilitate the selection process, referral page 800 may include test availability field 802 that is configured to identify whether a particular laboratory is capable of processing the patient's sample for which the consult order is being generated. In some embodiments, information displayed in test availability field 802 may be stored as data associated with a practice management system. For example, each laboratory may submit a list of available tests at the laboratory to an administrator or other user of the practice management system and the tests on the list may be associated with the laboratory in the practice management system in any suitable way. For example, the practice management system may include one or more databases that associate laboratories with available tests.

Although in the above-described embodiment a member of a laboratory may provide the available test information, it should be appreciated that the available test information may be collected in any other suitable way. For example, the associations between tests and laboratories may be based, at least in part, on historical data in the practice management system in which a referral was made to a particular laboratory for a particular test and a corresponding result was transferred back to the referring party or a patient. Such a successful referral outcome may indicate that the laboratory is capable of performing a particular test and this information may be captured and stored by the practice management system. Similarly, information related to types of patient insurance a provider accepts or any other type of information displayed in a referral page may be provided by a receiving provider to an administrator of a practice management system, captured based on past successful (or unsuccessful) events in the practice management system, or may be provided to and stored by the practice management system in any other suitable way. For example, information about receiving providers may be provided by third parties or by using one or more publicly available sources including, but not limited to, searching web pages of receiving provider(s) to retrieve the desired information. Some or all of the retrieved information may be stored by the practice management system for use with some embodiments of the invention.

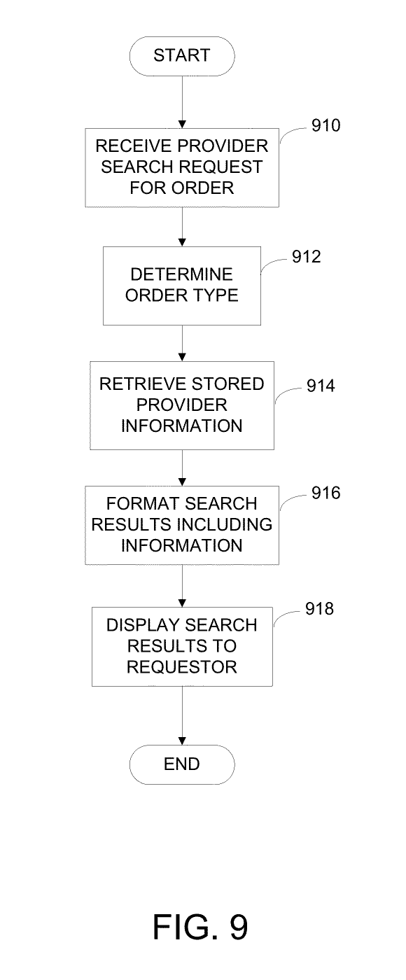

Some embodiments are directed to methods and apparatus for generating a referral page with which an ordering provider may interact to select a receiving provider for a consult order. FIG. 9 illustrates an exemplary method for generating a referral page based, at least in part, on provider information stored by a practice management system. In act 910, at least one processor in a practice management system receives a provider search request for a consult order. For example, a physician may initiate a search request for a specialist to refer a patient during a patient encounter at the physician's medical practice. The physician may initiate the request in any suitable way such as, for example, entering information about the referral into a page displayed as a portion of a web-based user interface hosted by a practice management system.

In response to receiving a request from a user, the process proceeds to act 912, where the order type is determined. For example, a physician may indicate that the referral is for a dermatology consult, and it may be determined in act 912 that the order type is “physician.” Alternatively, an ordering provider may initiate a search for a provider to process a blood test or perform an MRI, and it may be determined in act 912 that the order type is “laboratory,” or “imaging,” respectively. It should be appreciated that order types other than those listed above (i.e., physician, laboratory, and imaging) may also be used and embodiments of the invention are not limited in this respect.

After an order type is determined in act 912, the process proceeds to act 914, where stored provider information is retrieved from one or more data stores associated with the practice management system. In some embodiments, the provider information is retrieved based, at least in part, on the order type determined in act 912. For example, as shown in FIGS. 6-8 and as discussed above, searches for different order types may return different information for providers included in the search results. However, it should also be appreciated that at least some of the provider information returned for different order types may be the same or similar (e.g., patient insurance) and embodiments of the invention are not limited by the particular type of information that is associated with an order type.

In act 914, the information may be retrieved and/or determined in any suitable way. For example, in one embodiment, a component of the practice management system may store provider information about each provider associated with the practice management system. The provider information may be stored by the practice management system in any suitable way, such as in a database, a global provider directory, or any other searchable data store. As discussed above, the amount of information stored for different providers may vary from provider to provider. For example, providers who subscribe to an order facilitation service of the practice management system may be associated with more information than providers who are not subscribed to the service.

After retrieving provider information, the process proceeds to act 916 where the retrieved information is formatted as search results to be displayed to an ordering provider to facilitate a selection of a receiving provider for the consult order. In some embodiments, formatting the retrieved information may include selecting from the retrieved information an appropriate value based on one or more input characteristics of the search request. For example, a physician may initiate a search request for a dermatologist, and in response, a practice management system may retrieve provider information for each of the dermatology providers associated with the practice management system. In act 916, these results may be filtered by one or more characteristics of the search request such as distance from the referring provider, patient insurance type, test information, etc., to select appropriate values to return as search results.

In some embodiments, formatting received results comprises sorting the returned providers and their information based, at least in part, on one or more factors. For example, certain ordering providers may tag particular receiving providers as “favorites” and these receiving providers may be displayed at or near the top of a search results list (or in a different portion of a user interface) to facilitate a selection of one of these providers by the ordering provider if desired. Receiving providers may be sorted using any suitable criteria, and embodiments of the invention are not limited in this respect. For example, providers may be sorted based on distance from the ordering provider's medical practice, a frequency with which the provider is selected for a referral in the practice management system, the content of patient comments associated with the provider, or any of the categories of provider information retrieved from the practice management system. In some embodiments, formatting the retrieved information may include sorting the search results based, at least in part, on searches performed previously by an ordering provider or the frequency of selection by some or all providers subscribed to an order facilitation service or associated with the practice management system.

After the retrieved provider information has been formatted, the process proceeds to act 918 where the formatted information is displayed to the ordering provider who initiated the request. For example, after the appropriate values have been selected for each of the providers in the search results, a referral page displayed as a portion of a user interface on an ordering provider's computer may be updated to display the search results. In some embodiments an ordering provider may interact with one or more fields of the user interface to narrow the displayed results, perform a new search, or select one of the providers in the search results.

In some instances, different ordering providers within a single medical group refer patients having a similar diagnosis to different receiving providers for a consult and the information that is provided by an ordering provider to the receiving providers may vary from provider to provider. Additionally, some ordering providers may include detailed notes, instructions, and/or additional information with a consult order, whereas other ordering providers may not. This apparent lack of uniformity between providers in referral relationships often results in an inefficient referral system with unnecessary variation. The inventors have recognized and appreciated that this variation among providers may be reduced by informing ordering providers about particular information that a receiving provider requires to fulfill and bill a particular order. Accordingly, some embodiments are directed to facilitating a referral process by generating a clean order for a receiving provider based, at least in part, on stored data preferences for the receiving provider.

By enabling a provider to specify the information required to fulfill and bill for orders sent to the provider, a referral process between an ordering provider and a receiving provider may be facilitated. For example, when generating an order, an ordering provider may be informed about the information the receiving provider will need to complete the order rather than merely providing the information that the ordering provider thinks the receiving provider will need. Thus, rather than merely pushing information to a receiving provider, some embodiments of the invention enable receiving providers to pull information from ordering providers and/or a practice management system to facilitate the referral process.

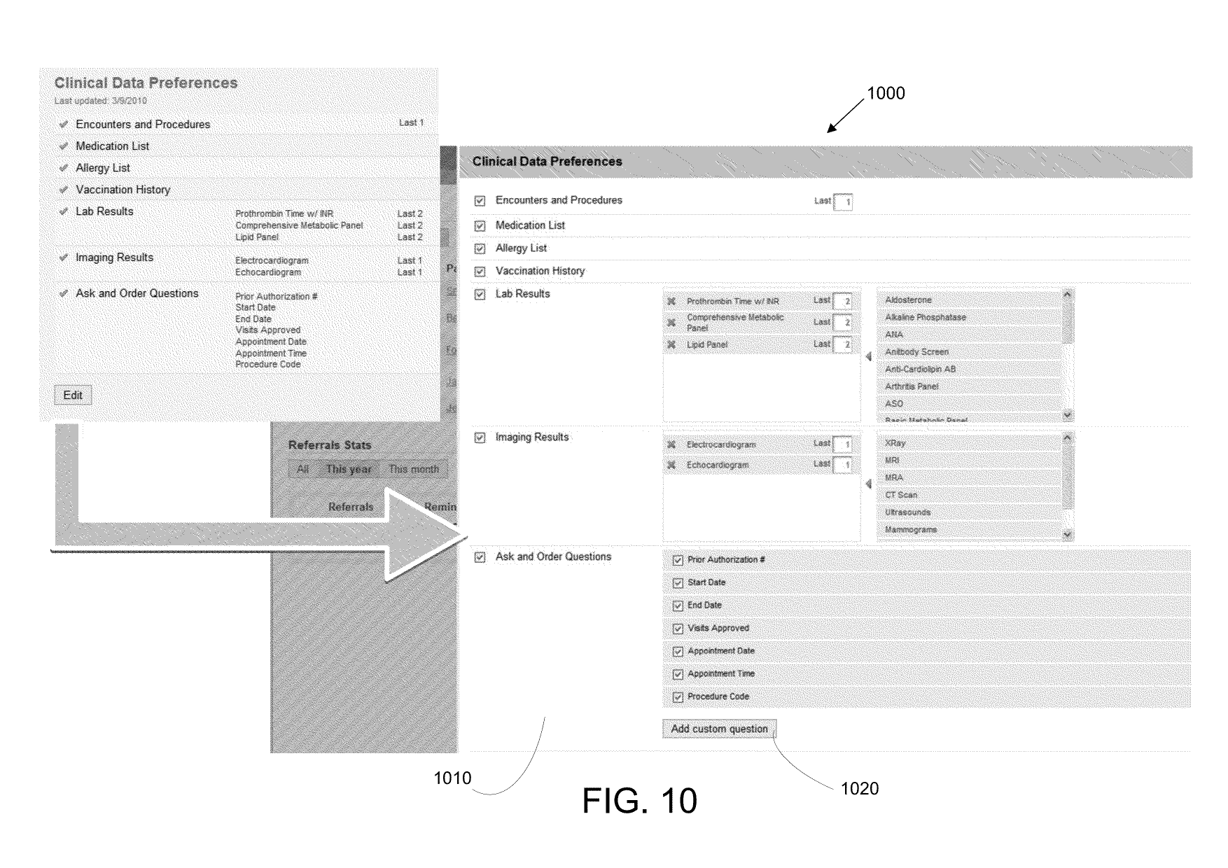

FIG. 10 illustrates an exemplary preferences page 1000 with which a provider associated with a practice management system may interact to input data preferences for consult orders sent to the provider. Preferences page 1000 may include a plurality of fields configured to enable a provider to select or deselect clinical data preferences for a consult order. In some embodiments, the plurality of fields may be categorized into a plurality of sections to facilitate the entry of data preferences. By indicating only the information that is necessary to fulfill and bill the order, receiving providers may be provided with a desired set of information that enables providers to efficiently process the order.

The inventors have recognized and appreciated that some providers have specific requirements imposed by payers that must be fulfilled to allow the provider to receive reimbursement for medical services provided to a patient. Accordingly, in some embodiments, in addition to medical history information, such as medications, allergies, and vaccinations, preferences page 1000 may also include one or more sections that facilitate a collection of provider-specific information. For example, preferences page 1000 includes question section 1110 that enables a provider to specify information specific to a particular order, which the provider may need to properly bill a payer for services provided to the referred patient. Order-specific information entered via question section 1110 may include any suitable information including, but not limited to, authorization information, a procedure code, appointment information, and a number of approved visits. Question section 1110 may also include custom question selector 1120 that, when selected by a provider, enables the provider to specify additional information not covered by other sections of preferences page 1000. Other sections and fields for entering data preferences into preference page 1000 are also possible and embodiments of the invention are not limited in this respect.

Although FIG. 10 illustrates a preferences page 1000 that may be presented to a physician to which patients may be referred, it should be appreciated that other types of receiving providers such as laboratories and imaging centers may also enter data preferences using preference pages. Depending on the type of provider, not all of the sections in preferences page 1000 may apply to each provider. For example, laboratory providers may not require information about a patient's imaging results. Accordingly, in some embodiments, different types of providers may input data preferences using preference pages customized for the particular type of provider. Customization may be performed in any suitable way including, but not limited to, deactivating portions of preference page 1000 that are not applicable to a particular type of provider and/or using different preference pages 1000 for different types of providers.

In some embodiments, only a subset of providers associated with a practice management system may be permitted to enter and store data preferences, although in other embodiments all providers associated with the practice management system may be permitted to enter and store data preferences. For example, in one implementation only providers who have subscribed to an order facilitation service hosted by the practice management server may be permitted to enter and store data preferences.

Data preferences entered via preferences page 1000 or another suitable user interface may be stored by one or more data stores associated with a practice management server as described above. In some embodiments, an order management component of the practice management system may implement one or more rules to keep track of order preferences between providers associated with the practice management system. In some embodiments the one or more rules may be stored by one or more data stores associated with the order management component and the order management component may be configured to execute the one or more rules stored by the one or more data stores in any suitable way.

An order management component of a practice management system may also interact with other components of the practice management system to facilitate referral processes in accordance with some embodiments of the invention. For example, the order management component may implement a plurality of rules that link information in a health information component of the practice management system with fields in a consult order generated by the order management component to generate a clean order for receiving providers.

Practice management systems used in accordance with some embodiments may include a plurality of service offerings to providers associated with the practice management system and each provider may choose to subscribe to one or more of the offered services. For example, as described above, some practice management systems may include an order facilitation service that facilitates a referral process between ordering providers and receiving providers by collecting and storing detailed information about each of the subscribed providers.

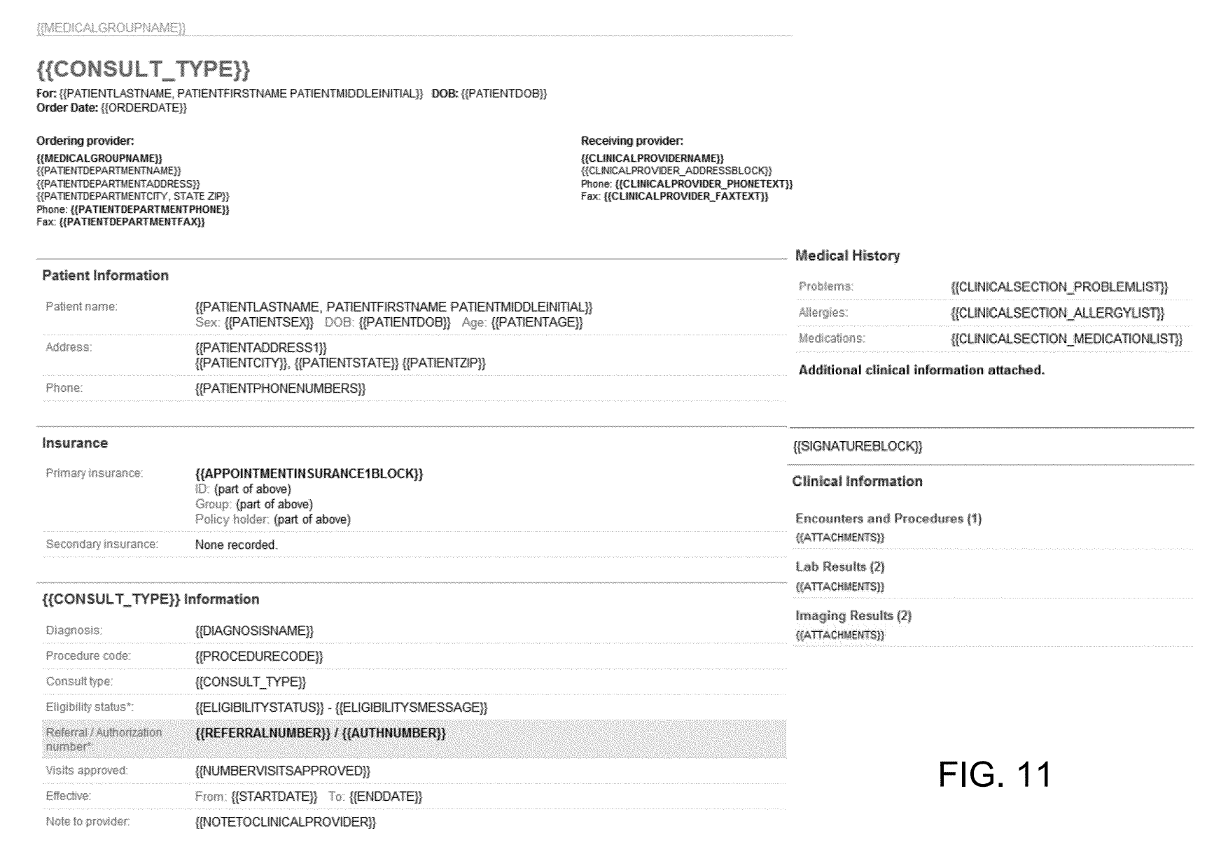

Another service that may be provided by a practice management system is maintenance of electronic health information by a health management component of the practice management system. Some providers may choose to subscribe to the electronic health information service, whereas other providers may choose to maintain health information records independent of the practice management system. In some embodiments, receiving providers who do not subscribe to an electronic health information service of a practice management system may nonetheless be provided with a clean and consistent consult order in accordance with some embodiments of the invention. FIG. 11 illustrates an exemplary consult order facsimile document generated for a provider who may not be subscribed to a health information management service in accordance with some embodiments of the invention.

Healthcare payers, such as insurance companies often require authorization of a referral prior to committing to remit payment for medical services provided by the receiving provider. However, the ordering provider is usually responsible for contacting the patient's healthcare payer to determine whether an authorization is required for a particular referral. Some embodiments are directed to facilitating an authorization process by storing information about which healthcare plans require referrals and providing the necessary authorization to an ordering provider when an order is created in association with a practice management system. By keeping track of and providing the necessary authorization information to ordering providers at the time an order is created, the burden on ordering providers during a referral process is reduced.

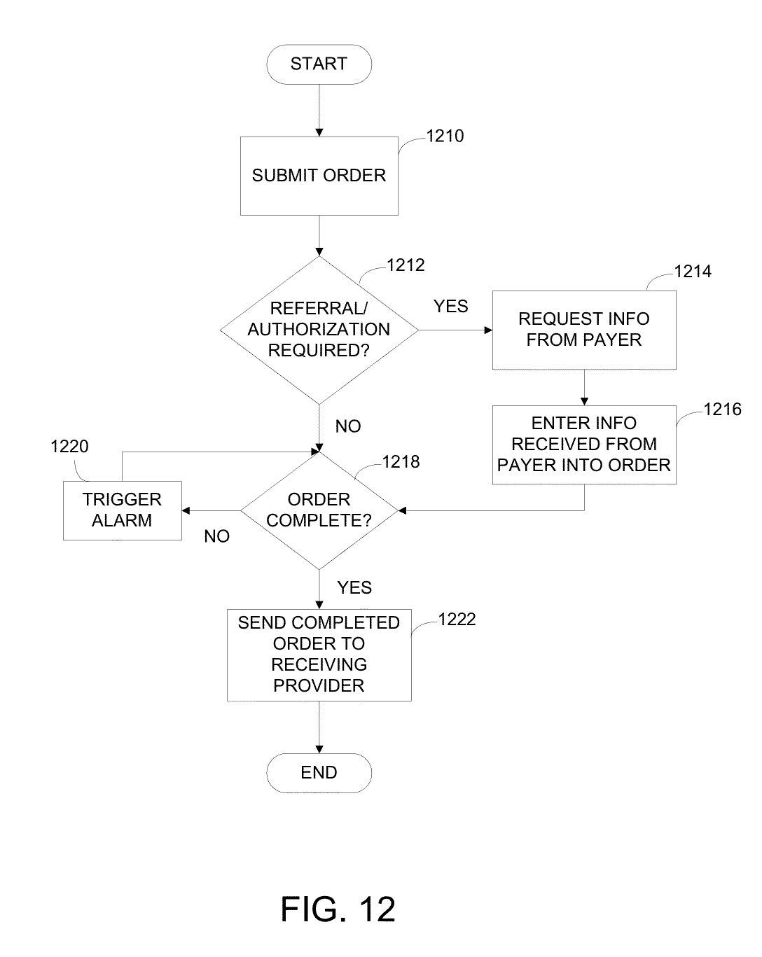

FIG. 12 illustrates a process for facilitating a referral authorization process in accordance with some embodiments of the invention. In act 1210, an ordering provider submits a consult order for a patient by, for example, interacting with a user interface provided by a practice management system as described above. The process then proceeds to act 1212 where it is determined whether a referral authorization is required for the consult order. Determining whether an authorization is required may be performed in any suitable manner and embodiments of the invention are not limited in this respect. In some embodiments, the practice management system may include one or more datastores configured to store authorization information for a plurality of healthcare plans offered by a plurality of healthcare payers associated with the practice management system. For example, the authorization information may specify whether a particular healthcare plan requires an authorization for referrals. In some embodiments, the stored authorization information may indicate that authorization is required for certain types of referrals under a particular healthcare plan, whereas authorization may not be required for other types of referrals under the healthcare plan. It should be appreciated that any suitable type of information to facilitate a determination of whether a consult order requires an authorization may be included in authorization information and embodiments of the invention are not limited in this respect.

If it is determined in act 1212 that authorization is required for the consult order, the process proceeds to act 1214 where information is requested from the healthcare payer associated with the patient's healthcare plan. For example, some healthcare payers may require a referral number and/or an authorization number to be included with the consult order. However, rather than requiring the ordering provider to contact the healthcare payer to determine this information, in some embodiments of the invention, an order facilitation component or an administrator of the practice management system may contact the appropriate payer to determine the required information on behalf of the ordering provider. The payer may be contacted to request information in any suitable way including, but not limited to, calling the payer and sending an electronic or paper message to the payer.

After requesting information from the payer, the process proceeds to act 1216 where the requested information is received from the payer and is entered into the order form for the consult order. In some embodiments, the requested information such as a referral number and/or authorization number may be electronically sent from the payer to the practice management system and the requested information may be automatically entered into the practice management system by the order facilitation component. Alternatively, the requested information may be provided verbally (e.g., via telephone) or in writing from the payer to an administrator of the practice management system and the administrator of the practice management system may manually enter the requested information into the practice management system. The particular manner in which the requested information is entered into the practice management system is not a limiting aspect of embodiments of the invention.

After the requested information is entered into a portion of the practice management system to be combined with the order or if it is determined in act 1212 that authorization is not required for the consult order, the process proceeds to act 1218 where it is determined whether the order is complete. As described above, an ordering provider may be responsible for selecting certain information to include in a consult order such as a particular receiving provider or comments related to the order.

If it is determined in act 1218 that the order is not complete, the process proceeds to act 1220 where an alarm is triggered to inform the ordering provider that the order is not complete. Any suitable alarm may be triggered to inform the ordering provider of an incomplete order and embodiments of the invention are not limited in this respect. For example, the alarm may be a communication such as an email or text message that is sent to a communication device of the ordering provider. Alternatively, one or more portions of a user interface that the ordering provider uses to access the practice management system may be modified to inform the ordering provider that the order is incomplete. For example, the practice management system may be configured to display an inbox to each user that describes open tasks for the user to complete and the alarm may be an indication in the ordering provider's inbox that the order is incomplete.

If it is determined in act 1218 that the order is complete, the process proceeds to act 1222 where the completed order is sent to the receiving provider. The completed order may be sent to the receiving provider in any suitable way and embodiments of the invention are not limited in this respect. For example, if the receiving provider is a user associated with the practice management system sending the completed order may comprise notifying the receiving provider that the completed order is available on the practice management system for viewing. The receiving provider may then access the practice management system to retrieve the completed order. The completed order may also be sent to the receiving provider via other methods including, but not limited to, facsimile and paper or electronic mail.

In some embodiments, an alarm may be triggered after a completed order form is sent to the receiving provider if, for example, a result has not been received from the provider in a particular amount of time or if the patient associated with the order did not follow through with the order. An alarm may be triggered in any suitable way including, but not limited to, the ways described above. Monitoring compliance by the receiving provider and/or the patient with consult orders generated by an ordering provider may alert the ordering provider to follow-up with the receiving provider or the patient to ensure that the referral process is completed in a timely manner.

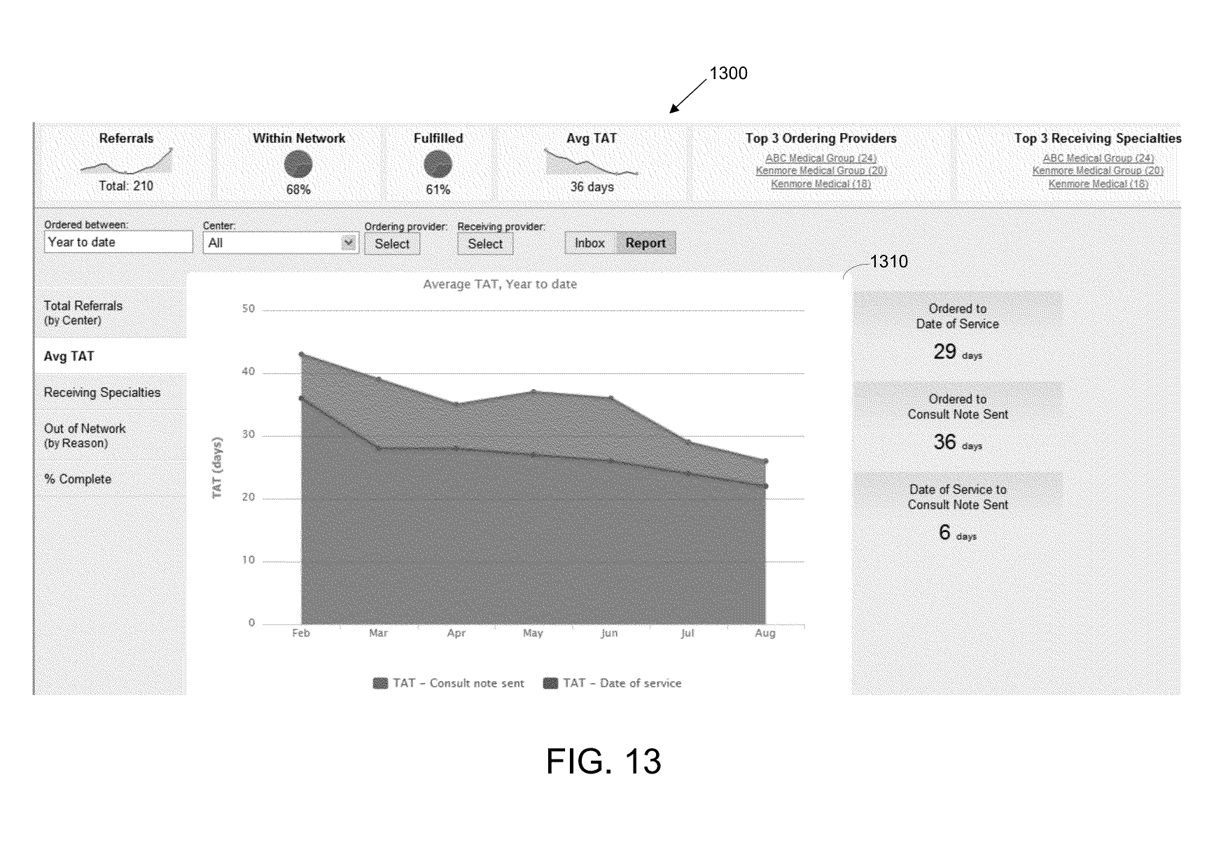

Some embodiments of the invention are directed to methods and apparatus for improved tracking and reporting of referrals between providers associated with a practice management system. FIG. 13 illustrates an exemplary report 1300 generated based, at least in part, on referral information stored by a practice management system. Report 1300 may include one or more graphs, tables, or any other suitable visualizations that enable a user to visualize metrics related to referral information stored by the practice management system. Report 1300 may also include one or more selectors or fields that enable a user to interact with report 1300 to select the underlying referral information that is used to generate the visualizations for particular metrics.

Exemplary report 1300 includes TAT graph 1310, which describes an amount of time that the referral process is taking (e.g., a “turn around time”) for providers associated with the practice managements system. TAT graph 1310 describes turn-around time metrics for two different scenarios although it should be appreciated any number or type of time efficiency metrics may alternatively be used and embodiments of the invention are not limited in this respect. TAT graph 1310 includes an indication of an average turn-around time from the time an order was generated by an ordering provider to the time when the patient's date of service at the receiving provider and an indication of a turn-around time for receiving a consult note from the receiving provider in response to providing a referral to the receiving provider. Additionally, report 1300 also includes numerical values to indicate turn-around time metrics including an amount of time between a patient's date of service at a receiving provider and when the receiving provider sends a consult note to the ordering provider.

In some embodiments, referral information displayed as a portion of report 1300 may be used by one or more receiving provider selection processes described above to facilitate a selection of a receiving provider by an ordering provider. For example, ordering providers may be interested in knowing which receiving providers have the lowest turn-around times for one or more of the above-described metrics. In some embodiments, an ordering provider may select one or more preferences that indicate referral metrics that are most important to the ordering provider and search results for receiving providers may be ranked based, at least in part, on the selected preferences. For example, an ordering provider may prefer to select a receiving provider that has an average turn-around time for sending out a consult note following a patient's date of service that is less than one week. In some embodiments, a practice management system may track referral metrics for providers associated with the practice management system and use this information to filter search results provided to an ordering provider.

In addition to turn-around time, report 1300 may also include other metrics that enable users of a practice management system to analyze referral information between providers of the practice management system. Other metrics may include, but are not limited to, volume of referrals, destination of referrals including in-network versus out-of-network, percent of referrals fulfilled, rates of referrals from particular providers, and types of patients being referred.

In some embodiments, the referral information displayed on report 1300 may be customized for providers within a certain medical group or specialty. For example, providers who are cardiologists may generally be more interested in certain types of referral information than providers who are neurosurgeons. Additionally, an administrator of a medical group may want to analyze the quantity and type of out-of-network referrals from providers within the medical group. Such an analysis is commonly called a “leakage” analysis, and some embodiments of the invention may be configured to facilitate a leakage analysis by providing out-of-network referral information including, but not limited to, referral frequencies, provider types, patient types, and reasons for the referrals.

In some embodiments, administrators of a practice management system may interact with report 1300 to identify providers who are exceeding thresholds on certain performance metrics and the information gained from such an analysis may be used to provide training for other providers that are underperforming on the metrics. It should be appreciated that report 1300 may be used for other purposes not described herein and embodiments of the invention are not limited in this respect.

Some embodiments of the invention are directed to a practice management system configured to enable ordering providers the ability to interactively schedule a patient with a receiving provider to which the patient is being referred. For example, the practice management system may include a scheduling component that stores scheduling information for a plurality of providers associated with the practice management system. In some embodiments, the interactive scheduling component of the practice management system may be offered as a service available only to providers who are subscribed to the service, although in other embodiments, the scheduling component may be accessible to all of the providers associated with the practice management system.

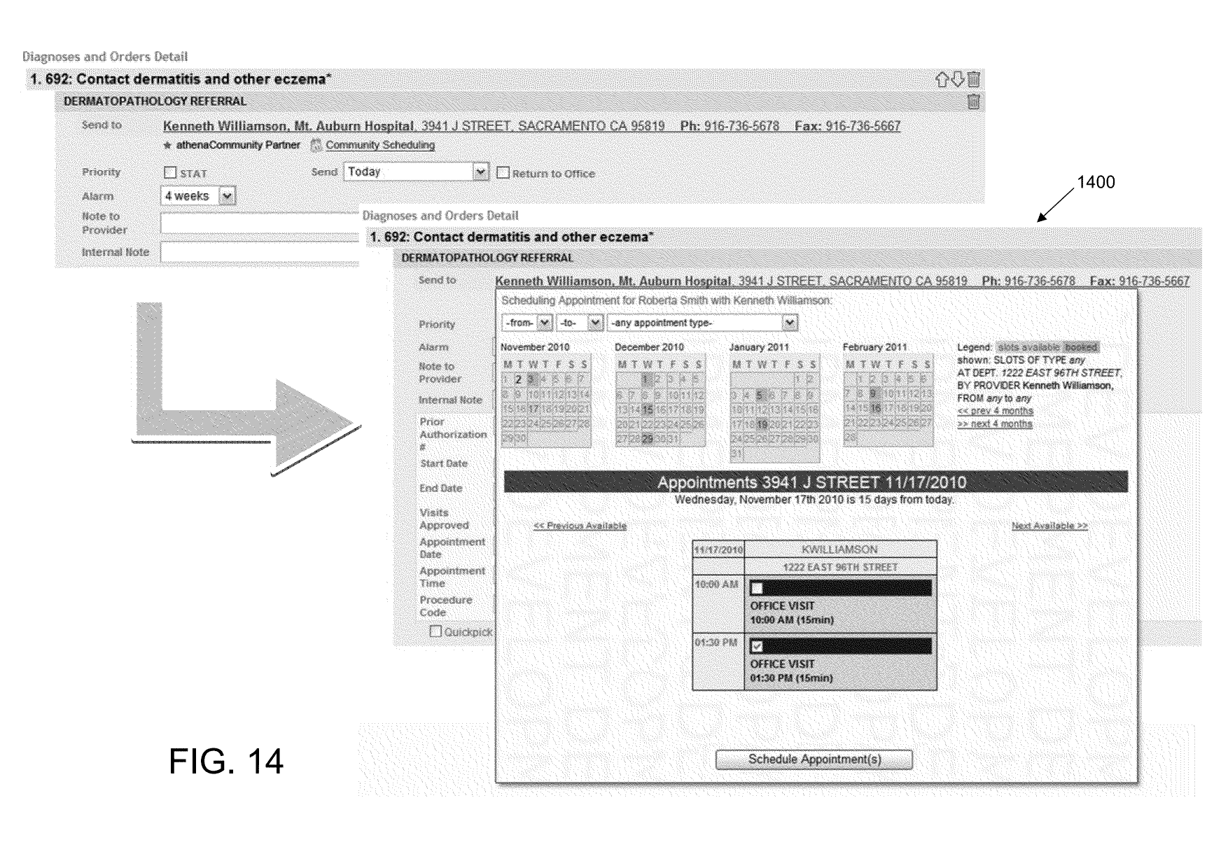

FIG. 14 illustrates an exemplary scheduling page 1400 with which an ordering provider may interact to schedule a patient with a receiving provider. In response to selecting a receiving provider, scheduling page 1400 may display appointment information for the selected receiving provider thereby enabling the ordering provider to directly schedule the referred patient without intervention from the receiving provider. Although some providers may elect to make scheduling functionality available to ordering providers to enable interactive scheduling of patients for referrals, other providers may not want to allow interactive scheduling. Accordingly, it should be appreciated that any combination of providers associated with a practice management system may participate in interactive scheduling provided they consent to such scheduling and embodiments of the invention are not limited in this respect.

Some embodiments are directed to ensuring that patients and/or receiving providers comply with a consult order generated by one or more of the processes described herein. For example, a consult order may be generated for a patient during a visit to the patient's primary care physician. The consult order may indicate that that patient should visit a specialist physician indicated on the consult order who may provide the patient with additional healthcare services. In some embodiments, a date indicating when the consult order was generated may be stored by the practice management system and this date may be used to determine whether a referral has been complied with.

As described above, a practice management system may include a communications component configured to send at least one communication to a patient or a healthcare provider associated with the practice management system. In some embodiments, the communications component may interact with an order management component, a scheduling component, or any other suitable component of a practice management system to determine whether a consult order generated using the practice management system has been completed. In one implementation, after a consult order has been generated, the practice management system may determine whether one or more actions associated with the consult order have been completed. For example, if the referral indicates that a patient should have follow-up blood work performed at a laboratory, a scheduling component of the practice management system may determine whether the patient associated with the consult order has visited the laboratory to perform the blood work.

In some embodiments, a communications component of the practice management system may send one or more communications to the patient to remind the patient of the consult order when it is determined that a particular amount of time has passed from when the consult order was generated by the practice management system. For example, an order management component of the practice management system may determine an amount of time since a consult order was generated by comparing a current date to a date stored by the practice management system that indicates when the consult order was generated. If the amount of time exceeds a predetermined value, the order facilitation management component may send a request to the communications component to send a reminder to the patient associated with the consult order. In turn, the communications component may determine patient information for the patient associated with the consult order, wherein the patient information includes contact information to enable the communications component to send one or more communications to the patient.

The contact information may be determined in any suitable way and embodiments of the invention are not limited in this respect. For example, the communications component may send a request for the contact information to another component of the practice management system such as a healthcare information management component, which is associated with one or more data stores configured to store the contact information for patients. Alternatively, the communications component may send a request to one or more data stores configured to store the patient contact information without first sending a request to another component of the practice management system. After patient contact information has been retrieved for the patient associated with a consult order, the communications component may send an automated message to the patient as a reminder to perform one or more actions associated with the consult order including, but not limited to, scheduling an appointment with the receiving provider indicated on the consult order.

In some embodiments, a communications component may send a communication based, at least in part, on an order type for a consult order. For example, if it is determined that the consult order is an imaging consult, a first type of communication may be sent using the communications component, whereas a second type of communication may be sent if it is determined that the order type is a physician consult. An order management component, a communications component, or any other suitable component of the practice management system may store one or more rules for generating a communication using a communications component.

Although the above example has been described with reference to using a communications component of a practice management system to send one or more communications to a patient associated with a referral, it should be appreciated that communications component may interact with the order management component of the practice management system to send one or more communications with other entities having contact information stored by the practice management system including healthcare providers and healthcare payers associated with a consult order. For example, after a patient has completed a visit to a receiving provider, the receiving provider may be required to send information back to the ordering provider associated with the referral to complete the referral process. In some embodiments, it may be determined whether this information has been sent to the ordering provider. When it is determined that the information has not been transmitted to the ordering provider, a communications component of the practice management system may send a reminder communication to the receiving provider to facilitate a completion of the referral process. It should be appreciated that the particular manner in which the reminder communication is sent to the receiving provider is not a limiting factor of embodiments of the invention as any suitable communication method may be used.

As described above, some embodiments are directed to an order facilitation service hosted by a practice management system that facilitates a referral process between healthcare providers including, but not limited to, physicians and other healthcare entities such as labs, imaging facilities, and durable medical equipment providers. However, generating referrals using such a service often involve care coordination costs for the practice management system. Such transaction costs may be covered by providers who pay a subscription fee when subscribing to the service. In such a pricing structure, ordering providers bear the entire transaction cost while also performing most of the work in generating the consult order. However, the receiving provider also benefits from receiving a clean consult order generated using the order facilitation service.

The inventors have recognized and appreciated that a pricing structure for transaction costs associated with an order facilitation service may be adjusted to reflect the benefit that both providers derive from consult orders generated via the order facilitation service in accordance with some embodiments of the invention. To this end, some embodiments are directed to an order facilitation service in which a determination of how to allocate a transaction cost for a consult order is based, at least in part, on whether the providers involved in the consult order are “trading partners” who are subscribed to the order facilitation service. By redistributing the transaction cost associated with generating a clean consult order using an order facilitation service of a practice management system, providers who subscribe to the order facilitation service may be charged a lower subscription fee, based, at least in part, on the fact that some receiving providers may be responsible for paying a transaction cost associated with a generating a clean consult order.

As discussed above, when a provider subscribes to an order facilitation service of a practice management system, the provider may be charged a subscription fee to cover at least some of the transaction costs associated with generating consult orders using the order facilitation service. As described herein, providers who subscribe to the order facilitation service may be considered “trading partners.” In some embodiments, receiving providers who are also trading partners may be assessed a transaction cost for generating a clean consult order. That is, rather than covering transaction costs for generating orders using subscription fees paid by providers subscribed to the order facilitation service, in some embodiments, a determination may be made whether the providers associated with a generated consult order are trading partners. When trading partners are involved in such a consult order, the receiving provider may be assessed a transaction fee for generating a clean consult order.

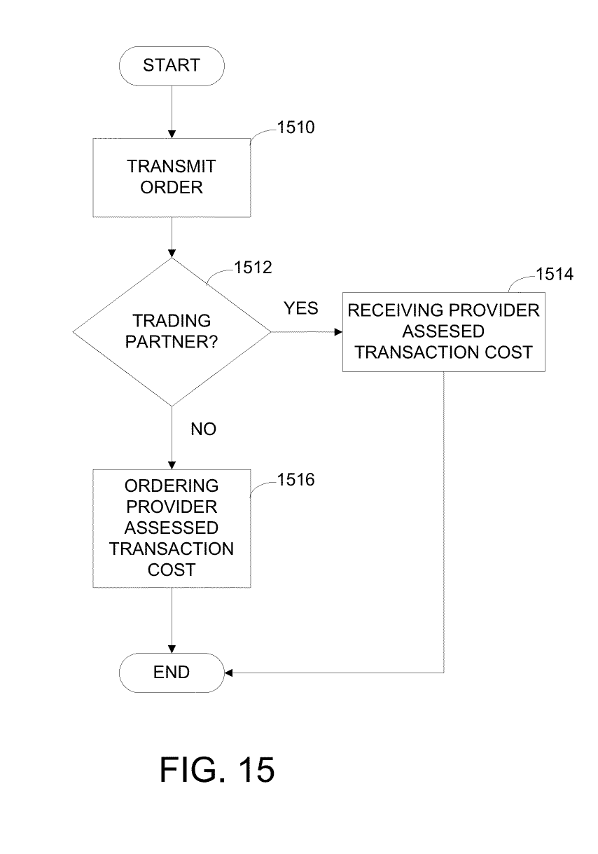

FIG. 15 illustrates an exemplary transaction cost analysis process in accordance with some embodiments of the invention. In act 1510, a consult order is created using an order facilitation service of a practice management system as described above. The process then proceeds to act 1512 where it is determined whether the receiving provider is a trading partner who has subscribed to the order facilitation service. If it is determined that the receiving provider is a trading partner, the process proceeds to act 1514 where the receiving provider is assessed a transaction cost for the generating the clean consult order. However, if it is determined in act 1512 that the receiving provider is not a trading partner, the process proceeds to act 1516 where the ordering provider is assessed a transaction cost for generating the consult order.

It should be appreciated that a transaction cost assessed to the ordering provider may be different than a transaction cost assessed to the receiving provider and embodiments of the invention are not limited in this respect. For example, in one implementation, a receiving provider who is a trading partner may be assessed five dollars per consult order to cover the services related to transacting a fully clean order. However, if an ordering provider decides to generate a referral to a receiving provider that is not a trading partner, the ordering provider may be charged one dollar per consult order to cover the service related to facilitating the transaction. In this exemplary implementation, the ordering provider may be charged a lower transaction fee than the receiving provider due to the fact that an order generated for a receiving provider who is not a trading partner may not be as clean as an order in which the receiving provider is a trading partner and supports and participates in the consult order generation process. It should be appreciated however that the fees described above, are merely exemplary and do not limit embodiments of the invention in any way.

In some embodiments, the transaction fees assessed to ordering providers and/or receiving providers may be based, at least in part, on a cost associated with transacting different types of orders. For example, a consult order for surgery or admission to a hospital may require a higher degree of patient and/or administrative coordination than a consult order for laboratory testing. Accordingly, transaction fees for consult orders which require more resources and coordination between parties may be higher than transaction fees for consult orders that are easier to generate.

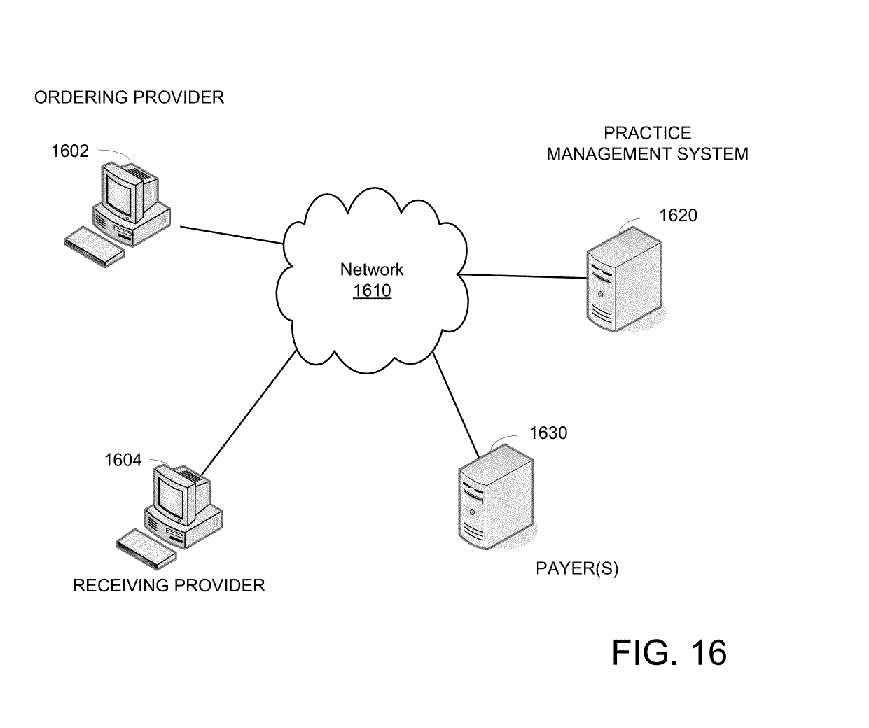

FIG. 16 illustrates an exemplary networked system on which some embodiments of the invention may be employed. Networked computers 1602 and 1604 located at healthcare service providers, payer computer 1630, and computer 1620 located at a location associated with a practice management system are shown connected to a network 1610. Network 1610 may be any type of local or remote network including, for example, a local area network (LAN) or a wide area network (WAN) such as the Internet. In the example of FIG. 16, four networked computers are shown. However, it should be appreciated that network 1610 may interconnect any number of computers of various types and the networked system of FIG. 16 is provided merely for illustrative purposes. For example, computer 1620 may be connected via network 1610 (or other networks) to a plurality of computers at a plurality of medical practice locations to provide practice management services to each of the connected medical practices. As should be appreciated from the foregoing, embodiments of the invention may be employed in a networked computer system regardless of the type or network size or configuration.

Having thus described several aspects of some embodiments of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a non-transitory tangible computer readable storage medium (or multiple computer-readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The indefinite articles “a” and “an,” as used herein, unless clearly indicated to the contrary, should be understood to mean “at least one.”

The phrase “and/or,” as used herein, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” shall have its ordinary meaning as used in the field of patent law.

As used herein in, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method of facilitating a referral between healthcare providers, the method comprising:
receiving a search request from an ordering provider to search for a receiving provider to associate with the referral, wherein the search request includes an order type for the referral;
retrieving based, at least in part, on the order type, provider information for a plurality of healthcare providers associated with a practice management system; and
displaying the retrieved provider information as search results to facilitate a selection of the receiving provider to associate with the referral.

2. The method of claim 1, further comprising:
receiving a filtering command from the ordering provider; and
filtering the search results based on the filtering command.

3. The method of claim 1, further comprising:
receiving a selection of one of the plurality of healthcare providers from the search results as the receiving provider to associate with the referral.

4. The method of claim 3, further comprising:
determining whether the selected receiving provider has stored data preferences; and
generating, when it is determined that the receiving provider has stored data preferences, a provider-specific consult order based, at least in part, on the stored data preferences.

5. The method of claim 3, wherein the stored data preferences includes clinical data preferences.

6. The method of claim 4, further comprising:
receiving input to complete the provider-specific consult order; and
generating a clean consult order based, at least in part, on the completed provider-specific consult order.

7. The method of claim 6, further comprising:
transferring the clean consult order to the receiving provider.

8. The method of claim 7, further comprising:
determining whether the receiving provider is a subscriber to an order facilitation service hosted by the practice management system; and
wherein transferring the clean consult order comprises sending, when it is determined that the receiving provider is a subscriber to the order facilitation service, an indication to the receiving provider that the clean consult order is available for viewing via a user interface provided by the practice management system.

9. The method of claim 3, further comprising:
displaying scheduling information for the receiving provider;
receiving a scheduling instruction to schedule a patient associated with the referral with the receiving provider; and
interactively scheduling the patient with the receiving provider based, at least in part, on the scheduling instruction and the scheduling information for the receiving provider;

10. The method of claim 9, wherein the scheduling information for the selected receiving provider is a scheduling calendar.

11. The method of claim 3, further comprising:
determining based, at least in part, on authorization information stored by the practice management system, whether the referral requires an authorization.

12. The method of claim 11, wherein the determination of whether the referral requires an authorization is based, at least in part, on healthcare payer information for a patient associated with the referral.

13. The method of claim 12, further comprising:
requesting, when it is determined that the referral requires an authorization, an authorization code from a healthcare payer identified by the healthcare payer information.

14. The method of claim 13, further comprising:
receiving the authorization code from the healthcare payer; and
generating an consult order for the referral, wherein the consult order includes the authorization code.

15. The method of claim 1, wherein retrieving provider information for the plurality of healthcare providers comprises accessing a global provider directory stored on a data store associated with the practice management system.

16. The method of claim 1, further comprising:
displaying the search results based, at least in part, on at least one preference stored by the practice management system, wherein the at least one preference includes a list of frequently-selected providers.

17. The method of claim 1, wherein the provider information includes healthcare payer information indicating whether each of the plurality of healthcare providers accepts the healthcare insurance for a patient associated with the referral.

18. The method of claim 1, wherein the provider information includes test availability information indicating whether each of the plurality of healthcare providers is capable of performing one or more tests associated with the referral.

19. The method of claim 1, wherein the order type is selected from the group consisting of a physician consult, an imaging consult, a laboratory consult, and a durable medical equipment consult.

20. A method of determining transaction costs associated with an order facilitation service hosted by a practice management system, the method comprising:
receiving via the order facilitation service, a selection of a receiving provider by an ordering provider;
determining with at least one processor, whether the receiving provider is subscribed to the order facilitation service;
assessing a first transaction cost to the receiving provider when it is determined that the receiving provider is subscribed to the order facilitation service; and
assessing a second transaction cost to the ordering provider when it is determined that the receiving provider is not subscribed to the order facilitation service.

21. The method of claim 20, further comprising:
determining the first transaction cost and/or the second transaction cost based, at least in part, on an order type for a referral between the ordering provider and the receiving provider.

22. At least one non-transitory computer-readable storage medium encoded with a plurality of instructions that, when executed by a computer, perform a method of determining transaction costs associated with an order facilitation service hosted by a practice management system, the method comprising:
receiving via the order facilitation service, a selection of a receiving provider by an ordering provider;
determining with at least one processor, whether the receiving provider is subscribed to the order facilitation service;
assessing a first transaction cost to the receiving provider when it is determined that the receiving provider is subscribed to the order facilitation service; and
assessing a second transaction cost to the ordering provider when it is determined that the receiving provider is not subscribed to the order facilitation service.

23. The at least one non-transitory computer-readable storage medium of claim 22, wherein the second transaction cost is less than the first transaction cost.

24. The at least one non-transitory computer-readable storage medium of claim 22, wherein the method further comprises:
determining the first transaction cost and/or the second transaction cost based, at least in part, on an order type for a referral between the ordering provider and the receiving provider.

25. A computer system, comprising:
at least one storage device configured to store a plurality of computer-readable instructions; and
at least one processor programmed to execute the plurality of computer-readable instructions to perform a method of tracking referrals between healthcare providers associated with a practice management system, the method comprising:
determining at least one performance metric for at least one of the healthcare providers, wherein the at least one performance metric includes a turn around time for referrals sent to the at least one of the healthcare providers; and
generating at least one referral report for the at least one of the healthcare providers, wherein the at least one referral report includes at least one visualization of the at least one performance metric.

26. The computer system of claim 25, wherein the method further comprises:
modifying search results for the at least one of the healthcare providers based, at least in part, on the at least one performance metric.

26. The computer system of claim 25, wherein the turn around time indicates an amount of time between a first time when a referral sent from an ordering provider to the at least of the healthcare providers and a second time when the at least one of the healthcare providers provides information back the ordering provider.

27. A method of tracking referrals between healthcare providers associated with a practice management system, the method comprising:
determining at least one performance metric for at least one of the healthcare providers, wherein the at least one performance metric includes a turn around time for referrals sent to the at least one of the healthcare providers; and
generating at least one referral report for the at least one of the healthcare providers, wherein the at least one referral report includes at least one visualization of the at least one performance metric.

28. A method of generating a clean consult order for a referral for a patient, wherein the referral is between an ordering provider and a receiving provider, the method comprising:
receiving preference information for the receiving provider, wherein the preference information includes information which the receiving provider requires to ensure that the receiving provider will be reimbursed by a healthcare payer for the patient;
generating, using at least one processor, a referral page including at least some fields for specifying the preference information;
receiving input from the ordering provider specifying at least some of the preference information; and
generating the clean consult order based, at least in part on the input from the ordering provider.

29. The method of claim 28, wherein at least some of the preference information is automatically entered into the referral page by at least one component of a practice management system with which the receiving provider and/or the ordering provider is associated.

30. The method of claim 29, wherein the practice management system includes a healthcare information management component, and wherein healthcare information for the patient is automatically entered into the referral page based, at least in part, on data stored in association with the healthcare information management component.

31. A practice management system configured to generate a clean consult order for a referral for a patient, wherein the referral is between an ordering provider and a receiving provider, the practice management system comprising:
an order management component configured to:
receive preference information for the receiving provider, wherein the preference information includes information which the receiving provider requires to ensure that the receiving provider will be reimbursed by a healthcare payer for the patient;
generate a referral page including at least some fields for specifying the preference information;
receive input from the ordering provider specifying at least some of the preference information; and
generate the clean consult order based, at least in part on the input from the ordering provider.

32. The practice management system of claim 31, further comprising:
a healthcare information management component configured to interact with the order management component to automatically enter healthcare information into the referral page based, at least in part, on data stored in association with the healthcare information management component.

33. A method of facilitating a referral between an ordering provider and a receiving provider associated with a practice management system including a scheduling component and a communication component, the method comprising:
determining whether the referral has been completed by accessing scheduling information for the receiving provider, wherein the scheduling information is stored by the scheduling component; and
sending via the communication component, at least one communication to the receiving provider and/or a patient associated with the order when it is determined that the referral has not been completed.

34. The method of claim 33, further comprising:
accessing patient information stored on at least one data store associated with the practice management system, wherein the patient information includes contact information for the patient; and
automatically sending the at least one communication to the patient based, at least in part, on the contact information.

35. The method of claim 33, further comprising:
determining an order type for the referral based, at least in part, on an identity of the receiving provider; and
sending the at least one communication based, at least in part, on the order type.

36. The method of claim 33, further comprising:
determining an amount of time that has passed since the referral was sent to the receiving provider;
determining whether the amount of time exceeds a predetermined value; and
sending the at least one communication when it is determined that the amount of time exceeds the predetermined value.

37. A practice management system configured to facilitate a referral between an ordering provider and a receiving provider, the practice management system comprising:
a scheduling component configured to store scheduling information;
a communication component configured to send communications to providers and/or patients; and
at least one processor programmed to facilitate an interaction between the scheduling component and the communication component by performing a method comprising:
determining whether the referral has been completed by accessing the scheduling information stored by the scheduling component; and
instructing the communication component to send at least one communication to the receiving provider and/or a patient associated with the order when it is determined that the referral has not been completed.

38. A computer system, comprising:
at least one processor configured to host a practice management system, wherein the practice management system includes an order facilitation service to which healthcare providers associated with the practice management system may subscribe; and
at least one data store associated with the practice management system, wherein the at least one data store is configured to store a plurality of rules that interact with the order facilitation service to facilitate referrals between the healthcare providers associated with the practice management system.

39. The computer system of claim 38, wherein the practice management system includes a healthcare management component configured to interact with the order facilitation service to facilitate referrals between the healthcare providers associated with the practice management system.

40. The computer system of claim 38, wherein the practice management system includes a billing management component configured to interact with the order facilitation service to facilitate referrals between the healthcare providers associated with the practice management system.

41. The computer system of claim 38, wherein the practice management system includes a scheduling component configured to enable healthcare providers associated with the practice management system the ability to interactively schedule patients.

42. The computer system of claim 38, wherein the practice management system includes a communication component configured to send at least one communication to at least patient and/or at least one healthcare provider in association with referrals generated using the order facilitation service.
